(19) United States
(12) Patent Application Publication
(10) Pub. No.: US 2024/0220820 A1
(43) Pub. Date: Jul. 4, 2024

(54) SYSTEMS AND METHODS FOR USING MULTISTAGE CLASSIFICATION TO REDUCE COMPUTATION COMPLEXITY

(71) Applicant: DataShapes, Inc., Kentfield, CA (US)

(72) Inventors: Shmuel Shaffer, Kentfield, CA (US); Kristopher R. Buschelman, Kentfield, CA (US); Gray L. Selby, Kentfield, CA (US)

(21) Appl. No.: 18/147,265

(22) Filed: Dec. 28, 2022

(51) Int. Cl. G06N 5/02

(52) U.S. Cl. CPC G06N 5/02

(57) ABSTRACT

Some implementations of methods, apparatus and systems are directed to classifying data associated with input vectors. In some implementations, a multistage algorithm may be used to group knowledge elements, and to perform pattern recognition operations. In some particular implementations, multiple levels of classification may be performed in order to classify input vectors with reduced computational power.

### TECHNICAL FIELD

The present disclosure relates to pattern identification and pattern recognition, and more particularly to determining classification probability.

### BACKGROUND

Pattern recognition involves classification of data (patterns) based on either a priori knowledge or on statistical information extracted from the patterns. The patterns to be classified are usually groups of measurements or observations (vectors), defining points in a multidimensional space. A pattern recognition system may include a sensor that gathers the observations to be classified or described; a feature extraction mechanism that computes numeric or symbolic information from the observations; and a classification or description scheme that performs the actual function of classifying or describing observations, relying on the extracted features.

The classification or description scheme is usually based on the availability of a set of patterns that have already been classified or described. This set of patterns is termed the training set and the resulting learning strategy is characterized as supervised learning. Learning can also be unsupervised, in the sense that the system is not given an a priori labeling of patterns, instead it establishes the classes itself based on the statistical regularities of the patterns.

A wide range of algorithms can be applied for pattern recognition, from very simple Bayesian classifiers to neural networks. An artificial neural network (ANN), often just called a “neural network” (NN) or recurrent neural network (RNN), is an interconnected group of artificial neurons that uses a mathematical model or computational model for information processing based on a connectionist approach to computation. An ANN can be an adaptive system that changes its structure and/or parameters based on external or internal information that flows through the network. Artificial neural networks can be used to model complex relationships between inputs and outputs or to find patterns in data. For many years, academia and industry have been researching pattern recognition based on artificial neural networks. However, this research has yielded methods and algorithms that required substantial computation power as well as substantial memory.

Typical applications for pattern recognition are automatic speech recognition, classification of text into several categories (e.g. spam/non-spam email messages), the automatic recognition of handwritten postal codes on postal envelopes, or the automatic recognition of images of human faces. The last two examples form the subtopic image analysis of pattern recognition that deals with digital images as input to pattern recognition systems.

### SUMMARY

Some implementations of methods, apparatuses, systems, and computer program products including non-transitory computer-readable storage media are directed to classification of input data. In some implementations, a flexible classification platform includes determination of the probability that the input data was properly classified.

In some particular implementations, a flexible pattern recognition platform includes pattern recognition engines that can be dynamically adjusted to implement specific pattern recognition configurations for individual pattern recognition applications. Some implementations provide a partition configuration where knowledge elements can be grouped and pattern recognition operations can be individually configured and arranged to allow for edge, cloud or hybrid computing architecture for input classification. Some implementations provide concurrent or near concurrent input classification such as real-time pattern identification and recognition via an edge, cloud or hybrid computing architecture. In some implementations, the system is also data-agnostic and can handle any type of data (image, video, audio, chemical, text, binary, etc.). Still further, some implementations provide systems capable of providing proximity (fuzzy) recognition or exact matching, via a recognition engine which is autonomous once it has been taught In addition to automatically classifying the input into one of a plurality of labeled categories, the method determines the probability that input data was properly classified and provides a means for tracing the training input that influenced the specific classification.

According to a first class of implementations, methods, apparatuses, systems, and computer program products including non-transitory computer-readable storage media are provided for probabilistic classification. For instance, a system includes a memory, one or more processors, and logic operable to cause the one or more processors to: obtain, in association with a learning process, a plurality of input vectors; iteratively process the input vectors to compute a knowledge map; iteratively process the input vectors to determine metadata associated with one or more knowledge elements; determine whether an input vector is within a knowledge element (KE) based on the knowledge map and the metadata; and determine a probabilistic classification based of the determination.

According to a specific implementation of the first class of implementations, the probabilistic classification is set to have a probability of 1 if the input vector falls within an influence sphere of a specific KE.

According to a specific implementation of the first class of implementations, when the input vector does not fall within any specific KE, processing further includes identifying two or more KEs to which the input vector may belong, along with corresponding probabilities.

According to a specific implementation of the first class of implementations, the corresponding probabilities are a function of one or more of a distance of the input vector to an ith KE sphere, a number of input vectors that hit the ith KE sphere in a predetermined time window, a size of an influence distance of the ith KE sphere, a weighting function of the ith KE sphere, or a quality function of the ith KE.

According to a specific implementation of the first class of implementations, input vectors are identified that belong to a first KE and a second KE with substantially equal probabilities, and a multi-dimensional plane separating the first KE and the second KE is determined based on the identified input vectors.

According to a specific implementation of the first class of implementations, a classification probability value is determined based on the knowledge map and the metadata, and an action is determined based on the determined classification probability value if the probability value exceeds a predetermined threshold.

According to a specific implementation of the first class of implementations, the action includes one or more of: alerting a user device regarding determined probabilities, restarting a system, or identifying an object as belonging to a specific class.

According to a specific implementation of the first class of implementations, when the input vector does not fall within any specific KE, processing further includes: identifying two or more KEs to which the input vector may belong, identifying that neighboring KEs belong to the same class, and determining that the input vector belongs to the class with a probability of 1.

According to a second class of implementations, methods, apparatuses, systems, and computer program products including non-transitory computer-readable storage media are provided for multistage classification. For instance, a system includes a memory, one or more processors, and logic operable to cause the one or more processors to: obtain, in association with a learning process, a plurality of input vectors; iteratively process an input vector through an iteratively constructed stage based system model; determine whether the iterative process identified the input vector as belonging to a class; in response to determining that classification has not been achieved, continue to iteratively process through the stage based system model; and in response to determining that classification has been achieved, cause an action to be taken.

According to a specific implementation of the second class of implementations, the learning process includes one or more of: obtaining the plurality of input vectors; identifying a subset of input vector dimensions; constructing new training vectors using the identified subset of input vector dimensions; constructing a stage knowledge map based on the new input training vectors; or storing the identified subset of input vector dimensions and the knowledge map in association with an identification stage.

According to a specific implementation of the second class of implementations, the learning process is configured to continue iteratively until a classification of the input vectors is achieved.

According to a specific implementation of the second class of implementations, iterations of the learning process use different elements of an input vector.

According to a specific implementation of the second class of implementations, the identification of an input vector as belonging to a class includes one or more of: obtaining the input vector; retrieving a subset of input vector dimensions and a knowledge map associated with an identification stage; constructing a new input vector using the input vector and the subset of input vector dimensions; or processing the new input vector through a stage knowledge map.

According to a specific implementation of the second class of implementations, iterations of the classification use different elements of the input vector.

According to a specific implementation of the second class of implementations, in response to determining that classification has not been achieved, processing includes: performing logic to determine whether related stages were exercised; continuing to iterate through stages in response to determining that not all of the related stages have been exercised; and in response to determining that all of the related stages have been exercised, determining a probability of the input vector belonging to one or more classes based on neighboring classes.

According to a specific implementation of the second class of implementations, the action includes one or more of: generating an alert that the input vector is related to a class, or determining that the input vector belongs to the class with a probability of substantially one.

A further understanding of the nature and advantages of various implementations may be realized by reference to the remaining portions of the specification and the drawings.

### DESCRIPTION OF THE DRAWINGS

FIG. 1 is a schematic diagram illustrating an example system according to some implementations.

FIG. 2 is a schematic diagram illustrating the plug-in stack component of an example inspection server.

FIG. 3 is a schematic diagram illustrating software and hardware stack architecture according to some implementations.

FIG. 4 is schematic illustrating example system architecture according to some implementations.

FIG. 5 is a schematic diagram illustrating an example computing system architecture according to some implementations.

FIG. 6 is a flow diagram illustrating multiple feature extraction processes applied to an input.

FIG. 7 graphically illustrates a knowledge map for didactic purposes.

FIG. 8 graphically illustrates matching of input vectors to knowledge elements according to some implementations.

FIG. 9 is a flow chart showing a method directed to matching knowledge elements against input vectors.

FIGS. 10 thru 16 are charts that graphically illustrate a learning function according to some implementations.

FIG. 17 is a flow chart showing a method directed to a learning function according to some implementations.

FIG. 18 is a flow chart showing a method directed to a half-learning function according to some implementations.

FIGS. 19 and 20 are schematic diagrams illustrating interaction of pattern recognition system components.

FIG. 21 is a schematic diagram showing an example programmable logic circuit according to some implementations.

FIG. 22 is a schematic diagram showing an example programmable logic circuit according to some implementations.

FIGS. 23 to 26 illustrate how an implementation may process input vectors in a pipelining mechanism.

FIGS. 27A-C illustrate examples of the operation of the classification engine.

FIGS. 28A-B illustrate examples of a relationship between knowledge element weight value and an average distance between a knowledge element and the input vectors that are within the influence distance of that vector.

FIGS. 29A-C illustrate the difference between the “in/out” method and the probabilistic method.

FIG. 30 illustrates an example of a method to determine a plane separating between neighboring KEs.

FIGS. 31A-C provides a flowchart illustrating a method for determining and utilizing a probabilistic classification.

FIG. 32 provides a simplified illustration of utilizing the probabilistic classification to extend the boundaries of KEs.

FIG. 33 illustrates an example a multistage classification method to reduce computation complexity

FIGS. 34A-B provide a flowchart illustrating training of a classification model for a multistage classification system.

FIGS. 35A-B provide a flowchart illustrating the use of a multistage classification model.

FIGS. 36A-B provide a simplified illustration of an input vector in the vicinity of KEs with decaying probability fields.

FIGS. 37A-B provide a simplified illustration of another input vector in the vicinity of KEs with decaying probability fields

FIGS. 38A-B provide a simplified illustration of class probabilities.

FIG. 39 illustrates an example block diagram of an environment wherein calculation of classification probabilities may be performed.

FIG. 40 illustrates an example block diagram and various interconnections of an environment wherein calculation of classification probabilities may be performed.

### DETAILED DESCRIPTION

### A Overview of Pattern Recognition

Generally, pattern recognition involves generation of input vectors potentially through feature extraction, and comparison of the input vectors to a set of known vectors that are associated with categories or identifiers. One finds example logic for pattern identification and pattern recognition in the following five patents, whose disclosures are hereby incorporated by reference: U.S. Pat. Nos. 5,621,863; 5,701,397; 5,710,869; 5,717,832; and 5.740.326

A vector, in one implementation, is an array or 1-dimensional matrix of operands, where each operand holds a value. Comparison of an input vector to a known vector generally involves applying a distance calculation algorithm to compute the individual distances between corresponding operands of the input vector and the known vector, and in accordance to the distance calculation algorithm in use to combine in some fashion the individual distances to yield an aggregate distance between the input vector and the known vector(s). How the aggregate distances are used in recognition operations depends on the comparison technique or methodology used to compare input vectors to known vectors. There are a variety of ways to compare vectors and to compute aggregate distance. In some implementations, the resulting aggregate distance may be compared to a threshold distance (such as in the case of Radial Basis Functions). In other implementations, the aggregate distance can be used to rank the respective matches between the input vector and the known vectors (such as in the case of K Nearest Neighbors (KNN)). Selection of vector layout, comparison techniques and/or distance computation algorithms may affect the performance of a pattern recognition system relative to a variety of requirements including exact or proximity matching, overall accuracy and system throughput.

Using pattern identification and recognition, it is possible to recognize unknowns into categories. A system can learn that multiple similar objects (as expressed by one or more vectors) are of a given category and can recognize when other objects are similar to these known objects In some implementations, input vectors having known categories can be provided to a pattern recognition system to essentially train the system. In a particular implementation, a knowledge element is (at a minimum) a combination of a vector and an associated category. As discussed in more detail below, a knowledge element may include other attributes, such as arbitrary user data and influence field values. The knowledge elements may be stored in a memory space or knowledge element array, which as discussed below may be partitioned in a configurable manner. A knowledge map is a set of knowledge elements. In some implementations, a knowledge element, in addition to defining a vector and a category, may further be instantiated as a physical processing element (implemented, for example, in a logic processing unit of a Field Programmable Gate Array (FPGA) that encapsulates processing logic that returns a match result in response to an input data vector.

Data vectors form the basis for the knowledge elements stored in the knowledge map as their operands are the coordinates for the center of the element in n-dimensional space. These data vectors can be derived from analog data sources (such as sensors) or can be based on existing digital data (computer database fields, network packets, etc.). In the case of all analog data sources and some digital data sources, one or more feature extraction processes or techniques can be used in order to provide a data vector compatible with the knowledge map used by the pattern recognition system.

Pattern recognition systems can determine the category of an unknown object when it is exactly the same or “close” to objects they already know about. With a Radial Basis Functions (RBF)-based or similar technique, for example, it is possible for a machine to recognize exact patterns compared with the existing knowledge or similar (close) patterns given the objects defined by knowledge elements in the knowledge map. Further, the systems can expand their knowledge by adding a new instance of a knowledge element in a category (as defined by one or more input vectors), if it is sufficiently different from existing knowledge elements in that category.

For didactic purposes, pattern recognition using Radial Basis Functions (RBFs) is described. As disclosed in the patents identified above, there exists a class of algorithms termed Radial Basis Functions (RBFs). RBFs have many potential uses, one of which is their use in relation to Artificial Neural Networks (ANNs), which can simulate the human brain's pattern identification abilities. RBFs accomplish their task by mapping (learning/training) a “knowledge instance” (knowledge vector) to the coordinates of an n-dimensional object in a coordinate space. Each n-dimensional object has a tunable radius-“influence distance” (initially set to a maximum [or minimum] allowed value)—which then defines a shape in n-dimensional space. The influence distance spread across all n-dimensions defines an influence field. In the case of a spherical object, the influence field would define a hypersphere with the vector defining the object mapped to the center. The combination of a vector, the influence distance and a category makes up the core attributes of a knowledge element.

Multiple knowledge elements of the same or differing categories can be “learned” or mapped into the n-dimensional space. These combined knowledge elements define an n-dimensional knowledge map. Multiple knowledge elements may overlap in the n-dimensional space but, in some implementations, are not allowed to overlap if they are of different categories. If such an overlap were to occur at the time of training, the influence distance of the affected existing knowledge elements and the new knowledge element would be reduced just until they no longer overlapped. This reduction will cause the overall influence fields of the knowledge elements in question to be reduced. The reduction in influence distance can continue until the distance reaches a minimum allowed value. At this point, the knowledge element is termed degenerated. Also, at this point, overlaps in influence fields of knowledge elements can occur.

For pattern recognition, an unknown input vector computed in the same fashion as the vectors of the previously stored knowledge elements is compared against the n-dimensional shapes in the knowledge map. If the unknown data vector is within the influence fields of one or more knowledge elements, it is termed “recognized” or “identified.” Otherwise it is not identified. If the unknown vector is within the influence field of knowledge elements within a single category, it is termed “exact identification”. If it falls within the influence fields of knowledge elements in different categories, it is termed “indeterminate identification”.

As discussed above, to process object influence fields and to determine which one of the three result types (exact recognition, not recognized, indeterminate recognition) occurred in recognition operations, a distance can be calculated to facilitate the required comparisons. The data vector format should be compatible and linked with the distance calculation method in use, as is indicated by the formulas shown below. In practice it is computationally more expensive to use hyperspheres (Euclidian distances) to map the knowledge elements, as the corresponding distance calculations require more time-consuming operations. In these cases, the knowledge element can be approximated by replacing a hypersphere with a hypercube, in order to simplify the distance calculations.

The classic approach focuses on two methods, L₁ and L_{sup.} to approximate the hypersphere with a value easier to compute (a hypercube) L is defined as

$$\text{?} \vert \text{?} - \text{?} \vert ,$$

$$\text{?} \text{indicates text missing or illegible when filed}$$

and Lₛᵤₚ is defined as |DEVi−TVi|max, where DEVi is the value of vector element i of the knowledge element's vector and TVi is the value of vector element i of the input vector. L₁ emphasizes the TOTAL change of all vector element-value differences between the object's knowledge vector and the input vector Lₛᵤₚ emphasizes the MAXI MUM change of all vector element-value differences between the knowledge element vector and the test vector. However, as described further below, the pattern recognition system allows the use of other distance calculation algorithms, such as Euclidian geometry (true hypersphere) in addition to the Li and Lₛᵤₚ methods

A pattern recognition engine can be built to implement a RBF or other comparison technique to define knowledge maps, as described above, and different recognition system configurations. Besides comparison technique, key determinates of such an engine are the number of knowledge elements available, width of the data vector supported by the objects, the width and type of the vector operands, the distance calculation methods supported and the number of possible categories the machine can support. Moreover, a computerized machine can be built to define knowledge maps using Bayesian functions, linear functions, etc as the comparison techniques. The pattern recognition system described here can be implemented using any such functions. That is, the RBF implementations described here are only representative.

### B. Partition-Based Pattern Recognition System

Some particular implementations provide a highly-configurable pattern recognition system where a set of pattern recognition system attributes (such as vector attributes, comparison techniques, and distance calculation algorithms) can be configured as a so-called partition and selected as needed by a pattern recognition application. In some implementations, the memory space that stores knowledge elements can be partitioned, and a variety of pattern recognition system attributes can be dynamically defined for one or more of the partitions. In one implementation, a pattern recognition engine, such as hardware or a separate software module, maintains the knowledge maps and partitions, while a pattern recognition application accesses the knowledge maps by passing commands to the partition, such as configure, learn and recognize commands. In one implementation, the pattern recognition engine provides a set of application programming interfaces (APIs) that allow applications to define and configure partitions, as well as invoke corresponding partitions for learn and recognize commands.

A partition may include one or more of the following configuration parameters: 1) number of vector operands: 2) vector operand type; 3) vector operand width; 4) comparison technique; 5) distance calculation technique; and 6) maximum number of knowledge elements. A partition may also include additional parameter attributes that depend on one of the foregoing attributes. For example, if RBF is selected as the comparison technique, the initial influence field can be a capped maximum value (MAX Influence—the largest hyperspheres or hyper cubes) or a smaller value which is the distance to the nearest neighbor of the same category or another category. These influence fields can be reduced as additional knowledge is “learned” which is not in the same category, but within the current influence field of an existing knowledge element. In addition, since a partition identifies a comparison type, one or more learning operations may also be affected. For example, if KNN is selected for the comparison type, learned vectors may be simply stored in the knowledge map without checking to determine whether a new knowledge element vector overlaps an influence field of an existing vector, as influence fields are not part of the KNN algorithm.

As discussed above, a pattern recognition engine maintains a knowledge element array which is a memory space for one or more knowledge maps. Each knowledge map includes one or more knowledge elements, which itself includes a vector, and a category identifier. The system allows for partitioning of the number of available knowledge elements to enable concurrent sharing of the pattern recognition resources. This supports multiple users of the knowledge map functionality, or supports a knowledge map application that wants to use it in different ways (e.g., different feature extraction techniques, different initial maximum influence value, different minimum influence value, different distance calculation method). For example, in a vision application one partition might be used for gradient analysis, whereas another partition of the knowledge element array might be used for histogram analysis. The results returned from each partition might be combined in several application-specific ways to achieve a final-recognition result.

A pattern recognition application can invoke a particular partition by identifying the partition when passing a learn, configure, or recognize command to the knowledge element array. The pattern recognition functionality may return results including an identified category, as well as other data configured or associated with the category or a matching knowledge element(s). In one implementation, the pattern recognition engine can be configured to remember the partition identifier of the last command passed to it and apply the last-identified partition to subsequent commands until a new partition is identified.

An overall pattern recognition process may be defined or configured as a series or set of individual pattern recognition operations, each associated with a configured partition. In one implementation, the pattern recognition application can include decisional logic that effectively arranges the partitions in a serial or hierarchical relationship, where each partition can be included in a decisional node including other logic or operations that is traversed during a pattern recognition operation. Traversing the partitions can be done by a host processor, or can be offloaded to a co-processor, or even programmed into a programmable logic circuit, such as an FPGA.

### B.1. Partitions-Data Vectors and Operands

In the prior art, the width of the knowledge vector was fixed. This causes two problems First, in situations where the input knowledge is smaller than this fixed width, resources are wasted as the full width of the neuron array is not used for each neuron. In some cases this can be dramatic (e.g., a 5-byte input vector being stored in a 64-byte vector width which is fixed). Second, in other situations, the input knowledge might have a natural width wider than the fixed vector width. This could cause loss of fidelity as the data must be scaled down to fit into the vectors. In the pattern recognition system described herein, the width of the knowledge vector of the knowledge elements and test vectors is not fixed. Multiple vector widths (such as 1-, 2-, 4-, 32-, 64-, 128-, 256-byte words) are available to suit the knowledge provided by the application or feature extraction processes. With smaller vector widths, more knowledge elements are available using the same memory resources.

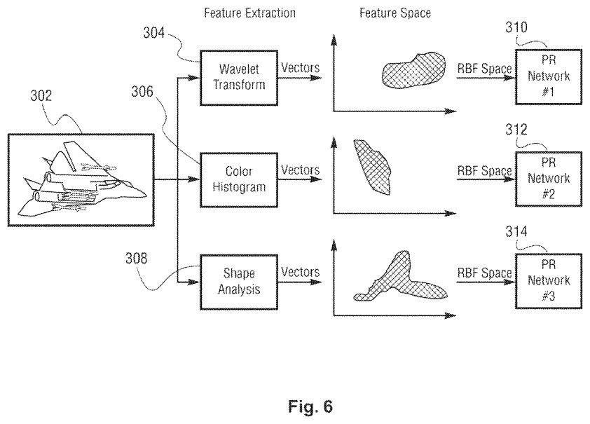

Still further, the pattern recognition system can be used with a variety of supported data types. Knowledge elements and test vectors can be represented with a data vector having operands or vector elements of a variety of widths (as described above) and data types (such as unsigned bytes, signed bytes, unsigned N-bit integers, signed N-bit integers, floating point values, and the like). A given data vector can be generated from already digitized information or information that being fed directly from a sensor. The sensor-based information may be first processed by a feature extraction process (as well as other processes), as shown in FIG. 6 FIG. 6 illustrates a plurality of feature extraction processes 304, 306 and 308 can process a given input data set 302, such as in image captured by an image sensor, to yield corresponding n-dimensional vectors positioned in their respective feature spaces. For example, a color histogram feature extraction process 306 may yield an n-dimensional vector, where n is defined by the number of color bins of the color histogram and the value of each operand is the number of pixels that fall into each respective color bin. Other feature extraction processes may yield or require vectors having a different number of operands, and operand types (such as different widths and data types). As FIG. 6 illustrates, each of the resulting data vectors can be applied to a corresponding pattern recognition network 310, 312 and 314, each contained within a partition and each including a knowledge map for training/learning and/or pattern recognition operations. In one implementation, a partition may be configured for each feature extraction process, where the number and type attributes of the vector elements are defined based on the requirements or properties of each feature extraction process. For example, the wavelet transform process 304 may require that a data vector having 15 elements or operands, each having an 8-bit width are configured. The color histogram process 306 may require a data vector with 30 operands or elements, each having a 32-bit width.

### B.2. Partitions-Comparison and Distance Calculation Techniques

As discussed above, a partition may be configured that identifies a comparison technique used to compare an input (test) data vector and a known vector of a knowledge element. Selectable comparison techniques include Radial Basis Functions, K Nearest Neighbor functions, Bayesian functions, as well as many others described in scientific literature Additionally, after a comparison technique is selected, one or more technique specific parameters may be configured (such as maximum and minimum influence fields for RBF comparisons). Further an interface is defined so that users of the pattern recognition system can build their own pluggable comparison technique modules, if those provided by the pattern recognition system are not sufficient. Additionally, if one or more applications with different needs are using the knowledge element array, one could set up each partition to use different pluggable comparison technique modules.

Still further, the algorithm for computing the distance between an input vector and a known vector can also be configured. For example, one from a variety of algorithms can be selected, such as Euclidian distance, L1, Lsup, linear distance and the like. As discussed above, however, L1 and Lsup are approximations of the true hyper-spatial distance which would be calculated using Euclidian geometry. In the pattern recognition system according to various implementations, the math for doing distance calculation is “pluggable.” This means that a given application can determine which math modules are available and request the one appropriate for its needs in terms of natural distance calculation, e.g., a module that uses Euclidian geometry and floating point numbers. Further an interface is defined so that users of the pattern recognition system can build their own pluggable distance calculation modules, if those provided by the pattern recognition system are not sufficient. In this manner, a user can set the width of the individual components of their input vectors, treat them as the appropriate data type (integer, floating point, or other) and can apply any distance-calculation algorithm that they desire or that the pattern recognition system chooses to provide. Additionally, if one or more applications with different needs are using the knowledge element array, one could set up each partition to use different pluggable distance calculation modules.

### B.3. Partitions—Weighting & Masking

In the prior art, there was no way to mask off portions of the existing knowledge of a vector or to weight different parts of the trained knowledge element vector as might be needed on subsequent recognition operations. For example, a set of knowledge elements might be trained on an entire image, but in some subsequent recognition operations only the center of the images might need to be taken into consideration. In the pattern recognition system according to one implementation, mask vectors and/or weighting vectors can be used when matching against an existing knowledge base. In one implementation, masking and weighting of operand vectors is part of a recognition operation In one implementation, an application may cause the pattern recognition engine to mask a vector operand by identifying a partition and the operand(s) to be masked in a mask command. An application may cause the pattern recognition engine to weight vectors operands by issuing a weight command that identifies a partition, the operands to be weighted, and the weighting values to be used. In one implementation the active influence field of a knowledge element may be temporarily increased or decreased to account for masking vectors or weighting vectors that may be currently in use.

### B.4. Partitions—Higher Level Recognition Operations

Partitions can be configured and arranged in a hierarchy or other structured relationship (series, parallel, branching, etc.) to provide for solutions to complex pattern recognition operations. A pattern recognition application, for example, may define an overall pattern recognition operation as a set of individual pattern recognition operations and include decisional logic that creates a structured relationship between the individual pattern recognition operations. In such an implementation, the results returned by a first set of partitions can be used as inputs to a second, higher level partition. For didactic purposes, the decisional logic can be considered as a set of decisional nodes and a set of rules and processing operations that define relationships between decisional nodes.

A decisional node, in a particular implementation, may comprise configured logic, such as computer readable instructions, that includes 1) operations applied to one or more inputs prior to calling a pattern recognition engine; 2) calls to one or more partition-based recognition operations implemented by a pattern recognition engine, and/or 3) operations applied to the results returned by the pattern recognition engine. The decisional node may make calls to one or more partitions maintained by the pattern recognition engine. The additional logic of a decisional node can range from simple Boolean operations to more complex operations, such as statistical analysis and time series analysis. Furthermore, the operations responding to the results of pattern recognition operations can select one or more additional decisional nodes for processing.

In particular implementations, a decisional node can be implemented as a decisional node object, which is an instantiation of a decisional node class in an object-oriented programming environment In such an implementation, the class can encapsulate one or more partition operations (as corresponding API calls to the pattern recognition engine). The decisional nodes can be sub-classed to develop a wide array of decisional nodes. As discussed above, additional logic can be developed to establish relationships between decisional nodes as well, and can be configured to interact with other decisional nodes or user level applications to achieve complex, high order processing that involves pattern recognition. For example, in one implementation, a decisional node could be implemented as a finite state machine whose output could change as inputs are provided to it and the results of recognition operations are returned. The resulting state of the finite state machine, at any given time, can be an input to a higher level decisional node, which itself may encapsulate one or more partition operations as well as additional processing logic.

Processing operations associated with a decisional node or a configured set of decisional nodes can be implemented in a variety of manners. Partition operations can be performed by a pattern recognition engine (implemented as a separate thread or process of a general purpose computer, offloaded to a co-processor, and/or implemented in a programmable logic circuit), while the decisional nodes can be implemented as a series of programming instructions associated with a user level application. In other implementations, processing of the decisional nodes can also be offloaded to a co-processor, and/or implemented in a programmable logic circuit.

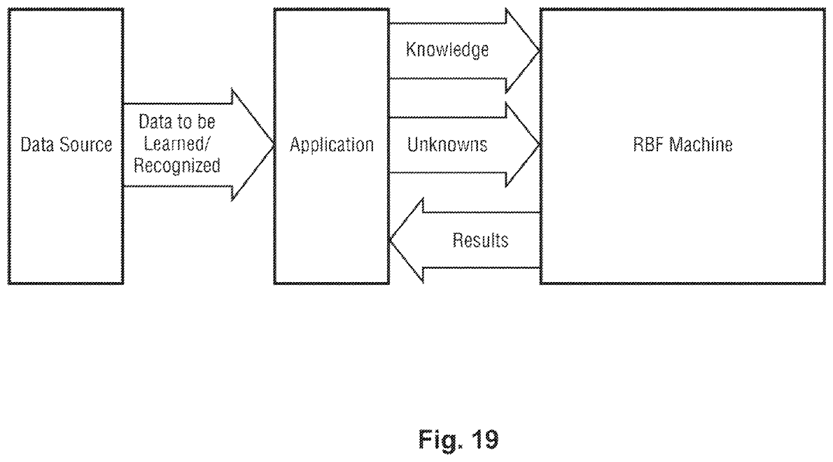

In the prior art, either a single recognition machine is used to identify a certain category of object or multiple recognition machines are used to identify an object when a majority vote wins. For example if two out of three recognition machines returned the same result, the object would be identified as that result. Further, in the existing prior art and scientific literature, RBF machines are used in a flat arrangement, as shown in FIG. 19. However there are large numbers of pattern identification problems where a flat arrangement cannot provide the desired results. These are normally situations where there is a large amount of detail (background and foreground) of different data types that must be processed in order to determine a final pattern recognition result. For example, one might apply a certain technique to input data and, if a match is found, then one might feed different data (based on the first match) calculated by a deferent technique into another recognition operation to determine a “higher level” recognition result.

Using the foregoing, a pattern recognition application can be configured to support a set of pattern recognition operations arranged in a hierarchy or other structured relationship that can be traversed to achieve a final recognition result. For example, a hierarchical configuration of pattern recognition operations can be configured where each decisional node of the hierarchy (pattern recognition partition(s) along with optional control/temporal logic) can identify a subsequent path to take. The results associated with one operational node of the hierarchy can be used to decide the next operational node to be executed and/or can be an input to a subsequent operational node. For example, the results of a first set of partition operations can become through combinational techniques, the input vector to a second, higher level partition or node operation.

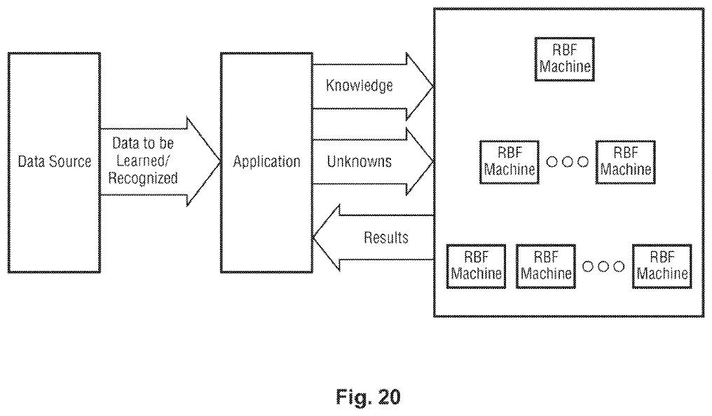

FIG. 20 illustrates a hierarchical recognition system, according to some implementations. A hierarchical recognition system, in one implementation, leverages the pattern recognition system's capabilities described here, including its capabilities with respect to opaque user data (as described in detail below), its partitioning capabilities, and/or its masking capabilities. When a knowledge map is taught a vector/category combination, the knowledge map allows opaque user data to be stored with knowledge elements as they are trained. The knowledge element/map does not process this information. It simply stores it and returns it to the application/user when the knowledge element is matched in a subsequent recognition operation. This opaque user data can be used for lookups (e.g., a key) or other user-defined purpose. This capability could be used to answer the question of why a certain vector fell into a specific category as the opaque data value returned could be used to look up the original training vector (and its source, e.g., picture, sounds, etc.) to present to a user or for use in an auditing application.

The opaque user data of multiple recognition operations could be used as an input vector (via combinatorial logic) to a higher level partition/node, or could also be used to lookup a data vector that could be used as an input vector (via combinatorial logic) to a higher level partition/node. In other implementations, the opaque user data could be used to look up a partition or decisional node to be processed next in a multiple layer pattern recognition application. For example, one recognition stage could use a first partition to provide a result. Via the use of opaque user-data, a subsequent recognition stage, using the same or a different input vector, could be performed in a different partition based on the opaque user data returned by the first recognition stage. This can continue for several levels. Additionally, once a higher level recognition result is achieved, it could be used to weight or mask additional recognition operations at lower levels in the hierarchy, such as to bias them toward the current top-level recognition.

Thus, a pattern recognition application may use multiple partitions or nodes to create the layers or it may create multiple independent layers and connect them as needed. The application decides which partitions/nodes are to be in which layers. To use such a pattern recognition system, the application trains specific knowledge elements with corresponding opaque user data (see above and below) into specific partitions. In the more simplistic case, a given unknown pattern may be presented to the appropriate partitions and the recognition result of each partition (combination of category recognized and/or opaque user data and/or derived data from the opaque user data), if any, would be fed to higher layers in the hierarchy. This process would repeat until a final recognition result was derived at the top of the hierarchy.

An example of this would be the lowest level of the hierarchy recognizing edges of a shape or sub-samples of a sound. Further up in the hierarchy, lines with intersecting angles would be recognized from image data along with tones from sound data. Still further up in the hierarchy, a four legged mammal would be recognized from the image data and the sound “woof” would be recognized from the sound data. Finally at the top of the hierarchy “dog” could be the final recognition result.

Or consider the following example. An image sensor might be pointed at a scene which includes a wall upon which a TV is mounted. First level pattern recognition might detect the corners and edges of the TV in the middle of their field of view. Once the individual elements were recognized, data associated with this recognition operation (e.g., the opaque user data in the pattern recognition system) might contain data on the position of the recognition in the overall scene (e.g., corner located at 2, 4, 8 and 10 o'clock). Similar results might be obtained for the edges. A higher level of recognition might conclude that these patterns in their respective positions formed a box. Recognition techniques using other different approaches might plot color changes. When these results are combined with all other techniques a final result of TV might be the determination at the top of the hierarchy. Once the TV is recognized, masking or weighting might be applied to lower levels in the hierarchy to focus only on the TV and ignore other objects in the scene being recognized, such as paintings on the wall, flying insects, books on a bookshelf, etc. A practical application of this example would be airport security where once a wanted person was identified by the facial patterns, tone of speech, type of clothing, fingerprint, etc., a computerized system could then “follow” this person throughout the facility continuously recognizing the person while somewhat ignoring the surrounding scene. In addition to the spatial examples defined above, additional levels in the hierarchy could use temporal (times series) pattern recognition operations to define their outputs. The input to these levels would be spatial recognitions that are then trended over time to produce a temporal recognition result.

A permutation on this case is that instead of just using one partition's or node's results to feed to a higher level partition or node, multiple lower level partitions could be combined into recognition units (or nodes). In this fashion probabilistic results can be feed further into the hierarchy. An example would be the lower level results are that there is an 80% probability, as opposed to a binary result in the simpler hierarchy.

Through experimentation, the correct numbers of levels are determined along with what to train/recognize in each level and what to feed up to higher levels. A starting point can be to use different knowledge vector feature extraction techniques at the lowest level and map these different techniques to different partitions/nodes. Next one would feed unknown knowledge vectors to the trained lower level to determine what was recognized. Based on these recognition results, the connection to the next level in the hierarchy would be created along with determining suitable feature extraction algorithms and associated logic for that level. In some cases the original training data would be used with different nth-order feature-extraction algorithms to train higher levels, or the output from the lower level (opaque user data or derived from opaque user data) would be used to train the higher level or a combination of the two. Each recognition problem domain may require experimentation to determine what the proper number of levels is, what the levels should be trained with and how they should be connected.

In the previous example, high fidelity recognition results can be obtained by feeding up through a recognition hierarchy. For time series (or temporal) recognition problems, it is also useful to feed a result from higher levels back to lower levels to bias them for the object being recognized and tracked. As an example, once a dog is recognized as barking, it can be advantageous to focus on the barking dog as opposed to blades of grass blowing in the background. The opaque user data could also be used to bias one or multiple levels of the recognition hierarchy once “sub recognitions” occurred at lower levels in the hierarchy to allow them to help focus the “desired” result.

In order to accomplish this, as each level recognizes a specific pattern, it could provide a bias to its own inputs or feed a bias to a lower level in the hierarchy to bias its inputs. This feedback would be accomplished the same way as the feed forward approach, namely, use (1) the recognition results' opaque user data or (2) what that data points to, to provide a bias to the same or a lower level. This would be accomplished by using the masking or weighting functionality described earlier.

### C. Enhancements to Logic for Pattern Identification and Pattern Recognition

As described in the paragraphs below, the system enhances pattern recognition functionality in a variety of manners, in one implementation, making the logic more useful to real-world applications.

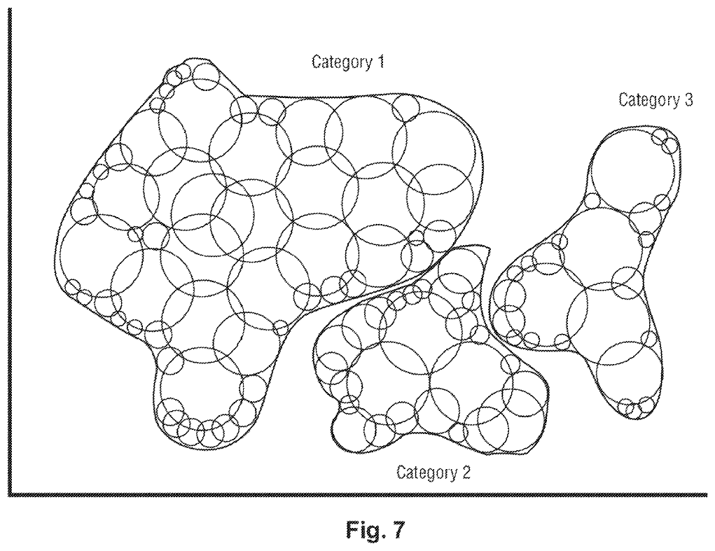

FIG. 7 shows an idealized, example pattern recognition knowledge map that might be defined for a two-dimensional (2D) vector type after array training has progressed to a near final state. Three categories have been defined. There is also an “other” category which is implied in the figure. Pattern recognition approximates the “real” knowledge category map (outer black lines) with a plurality of knowledge elements represented as circles in the idealized diagram of FIG. 7). With sufficient training, the difference between the real map and the approximate map can be quite small. In the case of RBF, knowledge elements are allocated to define a point in N-dimensional space, hold an influence field value (radius) and also remember their category (among other attributes). A collection of these knowledge elements in association with a partition is a knowledge map. As a data vector is taught to the knowledge element array (teaching=data vector+category+optional user data+learn command), it is mapped to the appropriate n-dimensional coordinate. If not within the influence of an existing knowledge element, a knowledge element is allocated for the data vector and then an initial influence field is applied along with the given category and optional user data. When this happens the current influence field of other knowledge element may be reduced so no overlap occurs where the categories would be different. In other words, the influence fields of knowledge elements on the boundary of a category in the knowledge map are reduced so as to not overlap with those in a different category. There is an influence field value (MIN Influence) past which the current influence field cannot be reduced. If this happens, the knowledge element is termed “degenerated.” Teaching data vectors which are not in a category (i.e., they are in the “other” category) is almost exactly the same (e.g., influence fields of existing knowledge elements may be adjusted), but no new knowledge element is allocated. As explained below, this process is called half-learning.

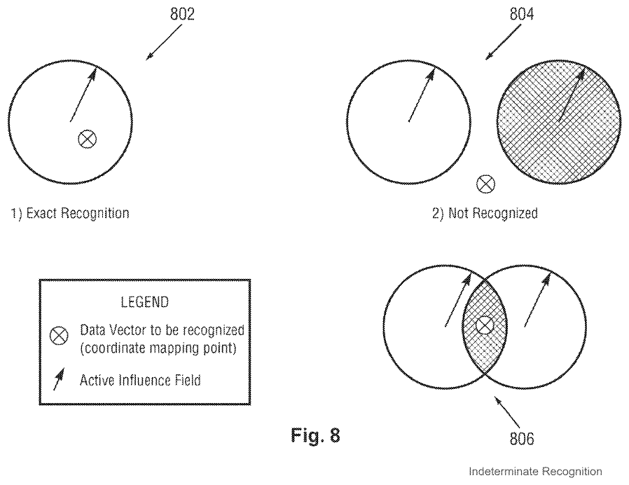

In the recognition phase, input (test) data vectors are presented to the knowledge map and, in one implementation, with a partition identifier. FIG. 8 below shows an example of these three recognition result types. The recognition result can be one of three types:
1. Exact Recognition (802)—The input vector fell within the influence field of knowledge elements of only a single category. The category of these knowledge elements is available to determine the type of information recognized.
2. Not Recognized (804)—The test vector fell outside the influence field of all knowledge elements. This could be a valid result (when an “others” category is appropriate for the knowledge map), or an indication that additional training using the test vector in question is warranted.
3. Indeterminate Recognition (806)—the test vector fell within the current influence fields of more than one knowledge element and those knowledge elements were of different categories. In this case, the category the smallest distance away can be used, the majority category value of the knowledge elements matched can be used, or as with the Not Recognized state, additional training may be warranted.

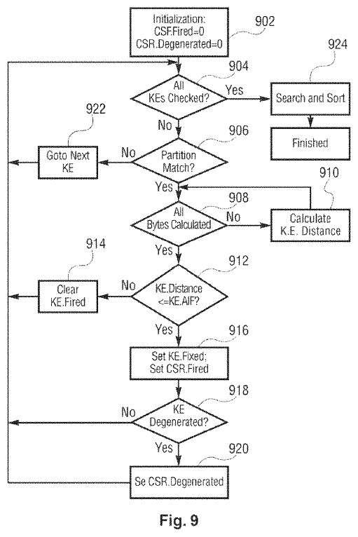

FIG. 9 shows an example flowchart of the logic depicted pictorially in FIG. 8. For example, an application may pass a recognize command to a pattern recognition engine identifying an input data vector and a partition. The pattern recognition engine may initialize one or more operational variables (902) and begin processing the input data vector. For example, the pattern processes the input data vector against all knowledge elements (KEs) (904, 922) that correspond to the identified partition (906). As to a given knowledge element, the pattern recognition engine may compute a distance between a first operand of the input vector and the corresponding operand of the knowledge element vector using the distance calculation algorithm of the identified partition, and repeats this process for all operands to compute an aggregate distance (KE.distance) (908, 910). Next, the pattern recognition system determines whether the aggregate distance between the input vector and the knowledge element vector is within the influence field of the knowledge element (912). If not, the pattern recognition system clears the KE.Fired flag that would otherwise indicate a match (914). If so, the pattern recognition engine sets the KE.Fired flag to indicate a knowledge element and category match (916). Additionally, if the knowledge element is a degenerated element (918), the pattern recognition engine sets a degenerated flag (920). In the implementation shown, after or as knowledge element comparison logic is executed, control logic searches the results and sorts the matching knowledge elements by the respective aggregate distances between the input vector and the knowledge element vectors (924). Other implementations are also possible. For example, if KNN is used, the comparison of influence field to aggregate distance would be omitted. In such an implementation, the top K matching knowledge elements are returned ordered by distance. Still further, if a test vector is matched because it falls within the active influence field of an existing knowledge element, this is a “fuzzy” or “proximity” match. To be an exact match, the test vector would have to be the same (exactly) as the knowledge vector of a knowledge element in the knowledge map. In one implementation, the pattern recognition system allows an application to select proximity (tunable) or exact matching.

### C.1. Optimization of Knowledge Vector Fields

In the prior art, an input vector presented for learning would be rejected if it falls within the influence field of an existing knowledge element in the same category. Yet a subsequent learning operation might allocate a knowledge element in another category which could cause the influence field of the original “matched” knowledge element to be reduced such that if the initial input vector was then presented, it would cause a new knowledge element to be allocated.

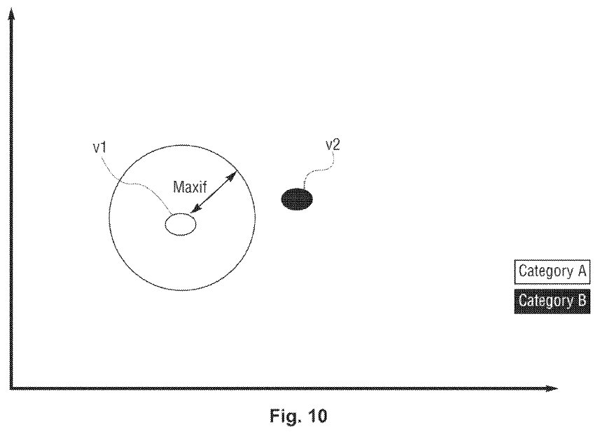

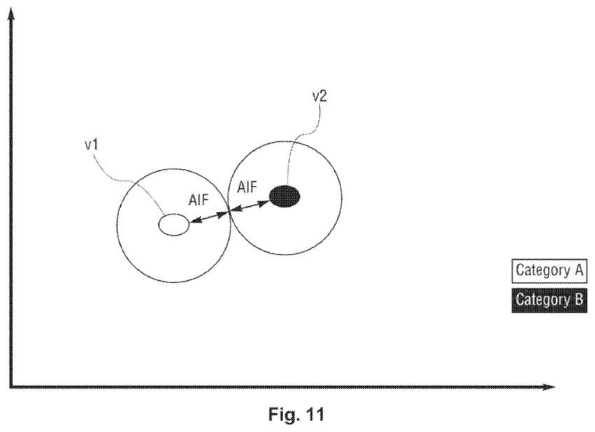

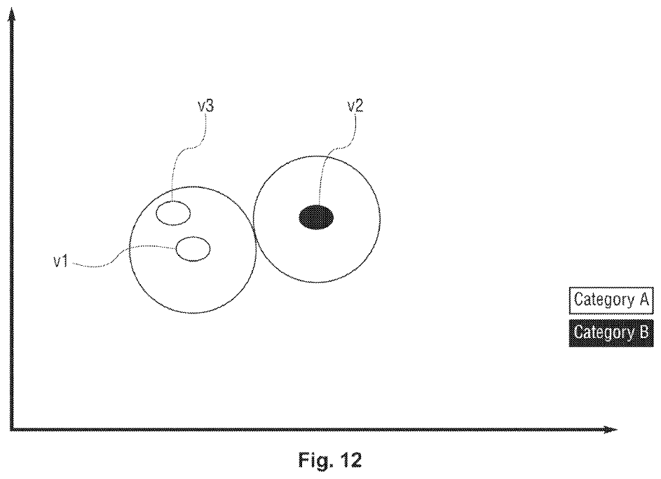

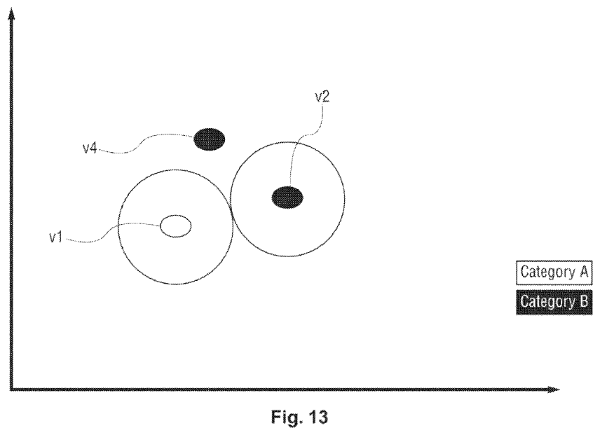

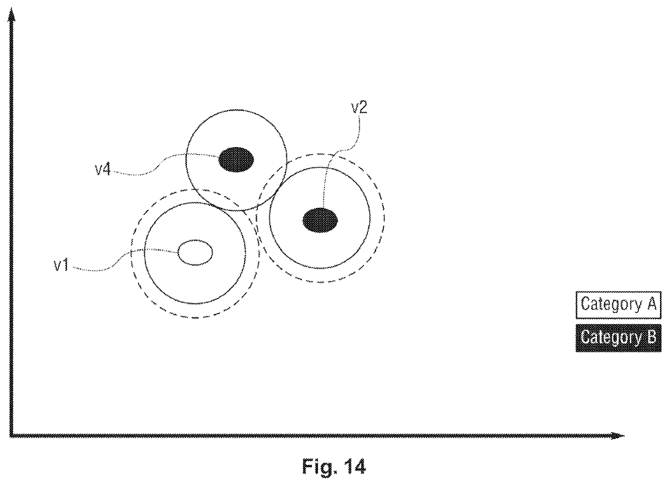

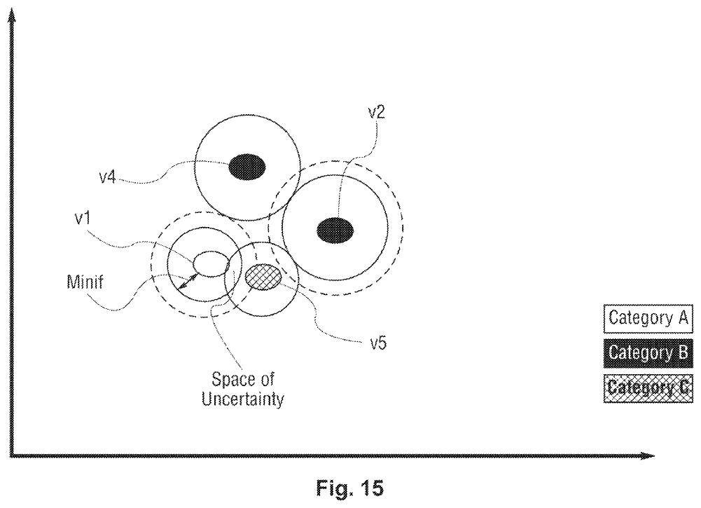

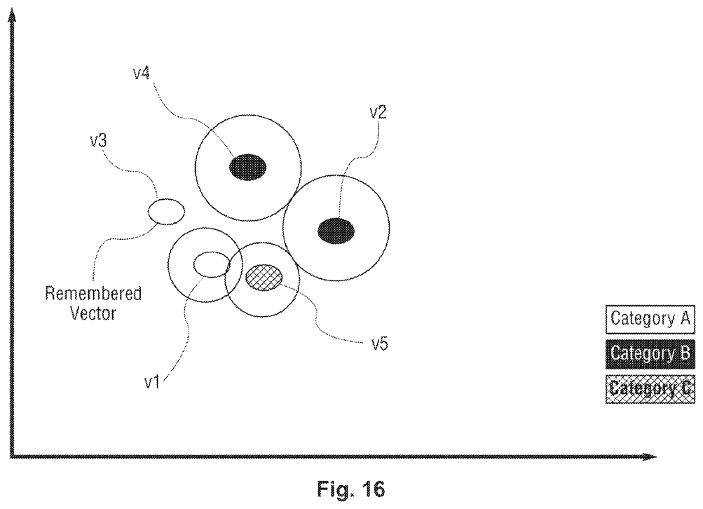

In the pattern recognition system according to some implementations, all vectors presented for learning that match against existing knowledge elements are remembered and are tried again if a subsequent learning operation reduces the influence field of any knowledge element in the array. In this way, knowledge density can be maximized to aid in increasing the sensitivity of subsequent recognition operations. This learning process is shown pictorially in FIGS. 10 through 16 for an example in a hypothetical 2-D space. FIG. 17 illustrates a method directed to the foregoing. FIG. 10 illustrates a learned vector v1 in category A and a learned vector v2 in category B. As FIG. 10 illustrates, the knowledge element corresponding to vector v1 has an influence field set to the maximum (Maxif) (see FIG. 17, 1702). Vector v2 is the next learned input vector (FIG. 17, 1704). As FIG. 11 illustrates, the influence fields of the knowledge elements for vectors v1 and v2 are adjusted to not overlap, since they have been assigned different categories (1706, 1708). In one implementation, the influence fields of each of the knowledge elements are adjusted equally to prevent the overlap. Other modes can be implemented as well. For example, the influence fields of a selected category can be favored by some weighting factor that causes the favored category to have a larger influence field. As FIG. 12 illustrates, vector v3, in the same category A as vector v1, lies within the influence field of an existing vector (again v1). Accordingly, vector v3 is initially omitted from the knowledge map in that no knowledge element is allocated, but saved for later processing (1706, 1716). FIG. 13 illustrates a vector v4 in Category B, which (as FIG. 14 illustrates) causes the influence field associated with vector v1 to be further reduced (1706, 1708). As FIG. 14 shows, in one operational mode, the influence field associated with vector v2 can also be reduced; however, in another operational mode, influence fields are adjusted only for overlapping knowledge elements in different categories. The selection of mode, in one implementation, can be another partition configuration attribute. FIG. 15 illustrates the addition of vector v5, which causes the influence field associated with vector v1 to reduce to the minimum allowed value (1706, 1708). As FIG. 16 shows, vector v3 no longer lies within the influence field associated with vector v1 and is allocated a knowledge element in the knowledge map (see FIG. 17, 1710, 1712 & 1714).

### C. 2. Half-Learning an Input Vector

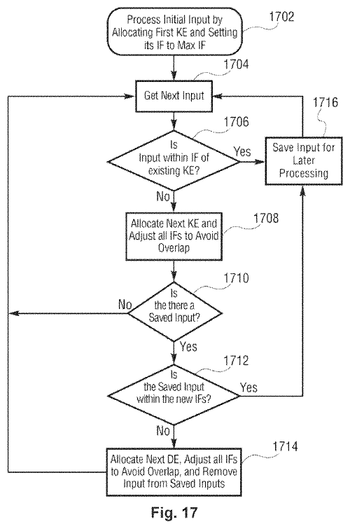

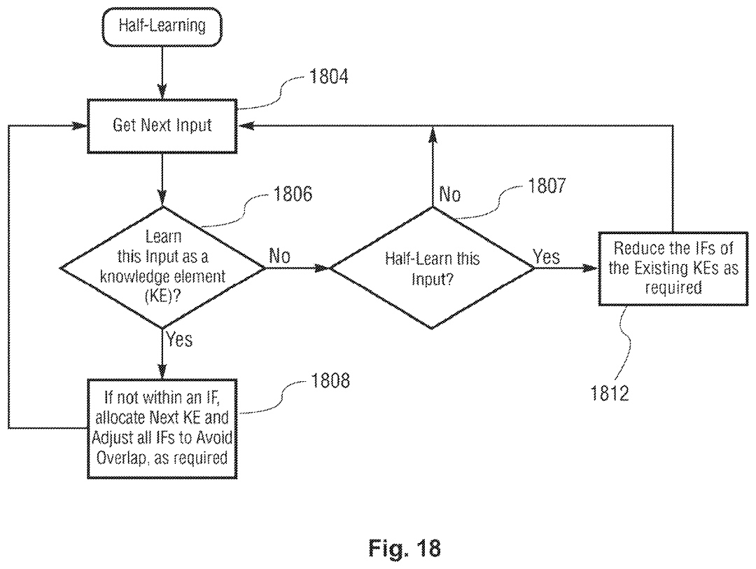

In many cases, additional input knowledge is not meant to be learned (e.g., allocated a knowledge element) but rather is only used to adjust the influence fields of existing knowledge elements to make sure they would not match the input data on a subsequent recognition operation. The pattern recognition system described here does allow this; it is termed “half-learning”. With half-learning, influence fields may be adjusted, but no new knowledge elements are allocated to preserve memory resources. As shown in FIG. 18, with each input to be learned (1804), the pattern recognition engine checks whether the learn command is a half-learn command or a regular learn command (1806). If a regular learn command, the pattern recognition engine allocates a knowledge element if the vector is not within the existing influence field of a knowledge element in the knowledge map and adjusts one or more influence fields as required (1808). If a half learn command (1807), the pattern recognition engine simply adjusts one or more existing influence fields as required (1812).

### C.3. Other Enhancements

In the pattern recognition system, the specific identifier, e.g. number, of the matched knowledge element (e.g., array index) is returned for all matched knowledge elements. Thus if an application keeps track of which knowledge element identifiers are allocated when training the knowledge element array, these identifiers can be used when matches occur to reference back to the source of the initial training knowledge, possibly in conjunction with the opaque user data, as described above. The ability to determine the precise knowledge elements which caused a match can be quite useful to a variety of applications. For example, the knowledge elements that did not cause a match may possibly be excluded when developing a knowledge map for the same application in order to save memory space and processing power.

Still further, the pattern recognition system may also maintain user and system counters for each knowledge element. A system counter is incremented each time a knowledge element is matched to an input vector. A user counter is incremented each time a knowledge element is matched to an input vector and when one or more user-defined rules are satisfied. In this manner, the significance of the trained knowledge elements can be assessed. For example, when developing a pattern recognition system for a specific application, such as machine vision in an auto assembly line, the system may be initially trained with 250,000 knowledge elements. Use of the system in a testing environment and analysis of the system and user counters may reveal, for example, that only 100,000 knowledge elements were ever matched and that many of the matched knowledge elements had an insignificant number of matches. An engineer may use this knowledge when implementing the field version of the pattern recognition system to exclude large numbers of knowledge elements, thereby reducing resources (processing and memory) for the given machine vision application.

In the prior art, it was not possible to delete existing knowledge if it was determined that that knowledge was in error. The only approach was to delete all the knowledge and retrain the knowledge element array again and not include the errant knowledge. This took time and required that the original knowledge be retained for subsequent training operations. The pattern recognition system, according to some implementations, allows individual knowledge elements to be deleted (cleared and marked as available) if it is determined that the knowledge they represent is in error. In addition, subsequent learning operations will use the knowledge elements previously deleted (if any) before the free knowledge element block at the end of the knowledge element array is used. When a knowledge element is deleted, it also triggers a reapplication of the “not learned knowledge,” if any (see Section D.1., above).

In addition, the pattern recognition system can also support configurable weighting values that can be selectively applied to knowledge elements of one or more categories to bias selection of for or against that category as to one or more input vectors. For example, the weighting factor can be used to increase the influence fields of RBF knowledge elements or to adjust the resulting aggregate distance computed between an input vector and a knowledge element vector. Again, this may be another configuration parameter for a partition.

In one implementation, the pattern recognition system supports a mode where a knowledge map is held static. For example, in a first dynamic mode, a given knowledge map can be augmented and changed as it is trained with new knowledge. The pattern recognition system also supports a static mode that disables further learning as to a select knowledge map. The fixed size (or further learning disabled mode) can be used to disallow knowledge updates which could cause non deterministic results when two similarly configured machines are modified independent of one another. In one implementation, the commands to enter and exit this mode may require an administrative password to allow for periodic updates, while protecting the knowledge map from updates by unauthorized personnel or applications.

As noted above, the pattern recognition system is implementation-agnostic and can be implemented using software in a general-purpose computing platform. Moreover, as noted above, the pattern recognition system is also amenable to implementation in firmware, hardware (FPGA or ASIC), combinations thereof, etc.

### D. Extendable System Architecture

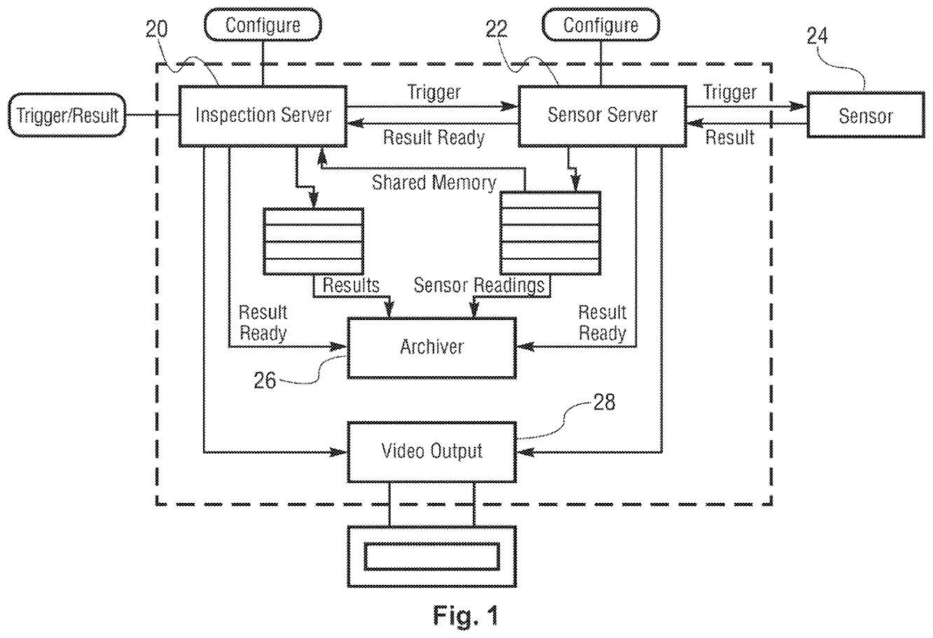

FIG. 1 illustrates an example functional system architecture according to one possible implementation of the pattern recognition system. In this implementation, the pattern recognition system includes two software-based servers that use the same shared memory. One of the servers is the sensor server 22, which initiates a trigger and then receives sensor readings from a sensor 24 (e.g., image, video, audio, chemical, text, binary, etc.). The other server is the inspection server 20 which triggers and receives results from the sensor server 22. As shown in FIG. 1, both the sensor server 22 and the inspection server 20 can be configured by a human (using for example a USB storage device or a network) or an automated user of the pattern recognition system. In the event that the pattern recognition system includes data sensors that are sensing data of different types (e.g., image and audio, radio frequency), the pattern recognition system might include another software- or hardware-based server (not shown), on the same system or possibly connected via a network (not shown), which combines the results of individual inspection servers to create a higher level or hierarchical result, as described in greater detail earlier. In the subject pattern recognition system, this is termed “sensor fusion”.

Additionally, as shown in FIG. 1, the pattern recognition system may include an archiver 26, where the system stores, (locally or remotely) among other things, results from the inspection server 20 and sensor readings from the sensor server 22. Also, as shown in FIG. 1, the pattern recognition system may optionally include a video output device 28 of some type, for display to a human user.

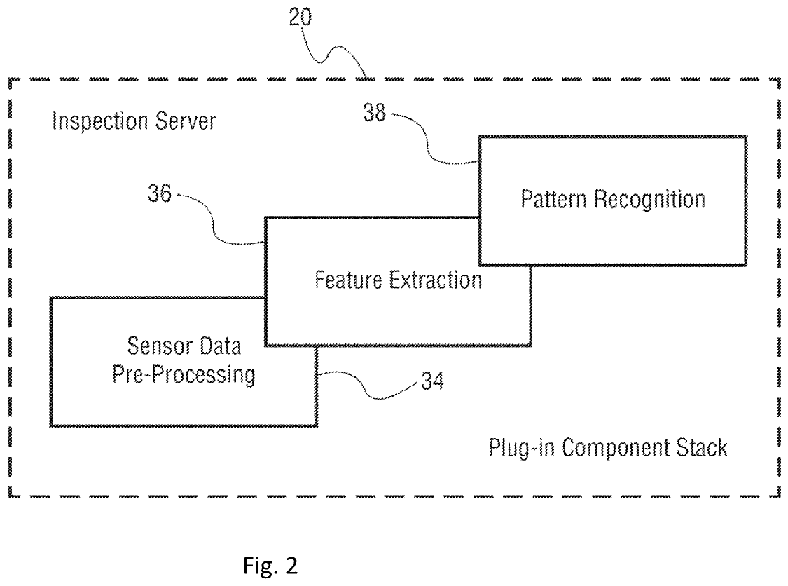

The pattern recognition system includes logic for pattern identification and pattern recognition, which logic is described in detail in this document That logic, in one implementation, resides in the inspection server 20 shown in FIG. 1. In some implementations, the pattern recognition system is a scalable system whose resources can be increased as needed. Also, in some implementations, the pattern recognition system is an extendable system, whose functionality can be readily extended via the use of general-purpose and special-purposes components. In one implementation, the pattern recognition system is extendable using a set of plug-in components relevant to the task at hand, e.g., machine vision utilizing feature extraction. By choosing the order a particular plug-in component is used during task performance, it is possible to control when invocation occurs with respect to the system logic for pattern identification and pattern recognition. FIG. 2 illustrates an implementation including a sensor data pre-processing component 34, a feature extraction component 36, and a pattern recognition component 38. See also FIG. 6, which illustrates that the pattern recognition system may take inputs from several feature extraction components during a machine vision task. Preprocessing of the sensory data may be performed prior to attempting pattern recognition and feature extraction. For example, if the task at hand is machine vision, this preprocessing might include filtering to reduce noise, improve resolution, convert to grayscale, etc.

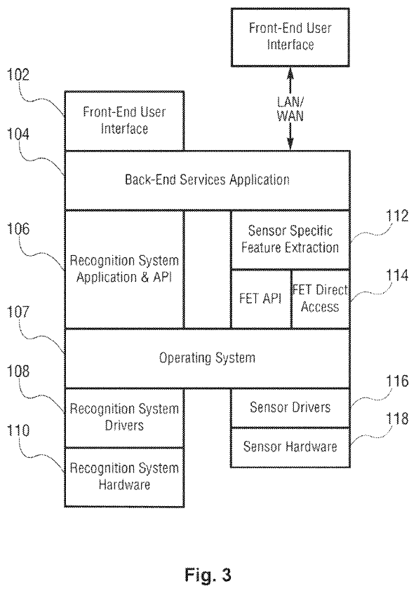

FIG. 3 is a more detailed picture of a possible component stack that includes feature extraction (FET) functionality. Operating system 107 may be any suitable operating system, e.g. Linux®, Windows® XP. As FIG. 3 illustrates, sensor drivers 116 may provide an API and command layer to sensor hardware 118. Feature extraction and sensor specific feature extraction API layers 112, 114 provide an interface to sensor drivers 116 via operating system 107 and may include functionality operative to pre-process raw data provided by the sensor hardware 118 to extract one or more features or attributes. As discussed below, pattern recognition processing may be offloaded to dedicated recognition system hardware 110, which may for example be a field programmable gate array (FPGA) or other programmable logic circuit implemented on a PCI or other card. Recognition system drivers 108 provide application programming interfaces to the hardware 110, while recognition system application and application programming interface (API) layer 106 provides interfaces to one or more pattern recognition applications (such as back-end services application 104). Back-end user services application 104 is operative to receive sensor input data and provide the input data, via recognition system application and API layer 106 to the recognition system hardware 110 for matching operations. Front-end user interfaces 102, 103 provide user interfaces to facilitate interaction with the pattern recognition system, such as configuration tasks, management tasks, and monitoring tasks.

A pattern recognition system can be hardware or software implementation-agnostic. That is to say, one can implement the pattern recognition system using: (1) software on an existing processor (e.g., Pentium, PowerPC, etc.), as indicated by the API in Appendix A; (2) HDL code for an FPGA (e.g., Xilinx Virtex-4, Altera Cyclone 3); (3) HDL Code in a semi-custom area of an existing generic processor (e.g., IBM Cell(REF)); and (4) full custom Application Specific Integrated Circuit (ASIC). In the case of chip-level implementations (e.g., 2-4 above), the chip might be mounted on a printed circuit board (PCB). This PCB could be on the main PCB for a computing machine or as an expansion PCB which would plug into an interconnect bus (PCI, PCI Express, etc.).

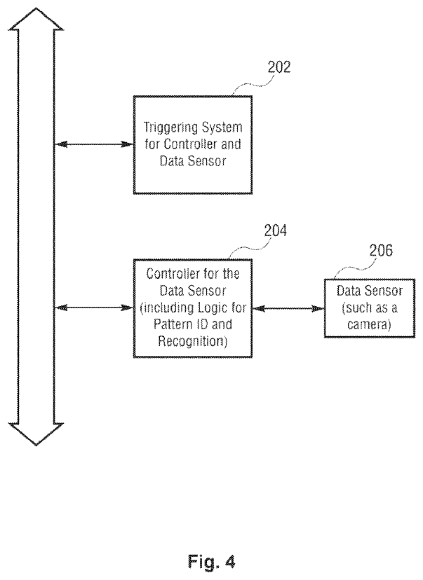

FIG. 4 shows an implementation where the pattern recognition system runs, and/or is integrated with, a controller 204 for a data sensor 206, which, e.g., might be a camera if the task to be performed is machine vision. More generally, a data sensor 206 is a device that contains one or more transducers that captures observed physical phenomena, such as sounds, images, radio-frequency signals, etc., and converts them into an analog or binary representation for digital processing of the sensed data. Further, in this implementation, there might be multiple controllers 204 for multiple data sensors 206, of the same or different types, e.g., a controller for a camera and a controller for a thermal imaging device, such as an infrared camera. Additionally, a triggering system 202 may trigger operation of the data sensor 206 and controller 204, such as when a new part is ready for inspection on an assembly line; or results may be presented asynchronously based on sensor readings.

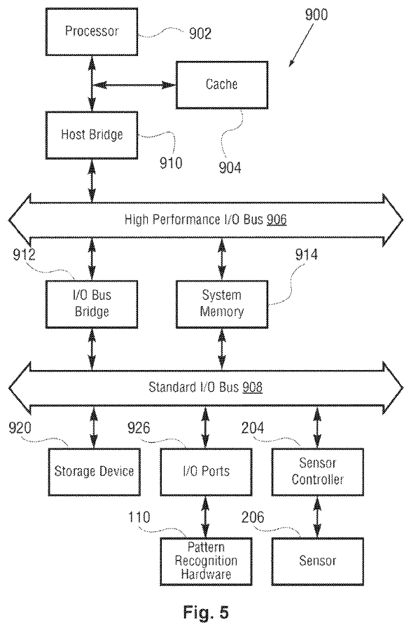

FIG. 5 illustrates for didactic purposes a general-purpose computing platform, and hardware architecture, which might use the sensor controller 204 shown in FIG. 4. In this implementation, hardware system 900 includes a processor 902, a system memory 914, sensor controller 204, and one or more software applications and drivers enabling the functions described herein.

Further in FIG. 5, hardware system 900 includes processor 902 and a cache memory 904 coupled to each other as shown. Cache memory 904 is often of two levels, one which is contained as a part of processor 902, and one which is external to processor 902. Additionally, hardware system 900 includes a high performance input/output (I/O) bus 906 and a standard I/O bus 908. Host bridge 910 couples processor 902 to high performance I/O bus 906, whereas I/O bus bridge 912 couples high performance I/O bus 906 and standard I/O bus 908 to each other.

Coupled to bus 906 are sensor controller 204, such as a camera system controller, and system memory 914. A sensor 206 is operably connected to sensor controller 204. The hardware system may further include video memory (not shown) and a display device coupled to the video memory (not shown). Coupled to standard I/O bus 908 bus 908 are storage device 920 and I/O ports 926. Collectively, these elements are intended to represent a broad category of computer hardware systems, including but not limited to general purpose computer systems based on the Pentium® processor manufactured by Intel Corporation of Santa Clara, Calif., as well as any other suitable processor.

The elements of hardware system 900 perform their conventional functions known in the art. Storage device 920 is used to provide permanent storage for the data and programming instructions to perform the above described functions implemented in the system controller, whereas system memory 914 (e.g., DRAM) is used to provide temporary storage for the data and programming instructions when executed by processor 902. I/O ports 926 are one or more serial and/or parallel communication ports used to provide communication between additional peripheral devices, which may be coupled to hardware system 900. For example, one I/O port 926 may be a PCI interface to which an FPGA implementation of the pattern recognition system hardware 110 is operably connected.

Hardware system 900 may include a variety of system architectures, and various components of hardware system 900 may be rearranged. For example, cache 904 may be on-chip with processor 902. Alternatively, cache 904 and processor 902 may be packed together as a “processor module,” with processor 902 being referred to as the “processor core.” Furthermore, certain implementations of the claims may not require nor include all of the above components. For example, storage device 920 may not be used in some systems. Additionally, the peripheral devices shown coupled to standard I/O bus 908 may be coupled instead to high performance I/O bus 906. In addition, in some implementations only a single bus may exist with the components of hardware system 900 being coupled to the single bus. Furthermore, additional components may be included in system 900, such as additional processors, storage devices, or memories.

As noted above in connection with FIG. 3, there are a series of application and driver software routines run by hardware system 900. These software routines comprise a plurality or series of instructions to be executed by a processor in a hardware system, such as processor 902. Initially, the series of instructions are stored on a storage device, such as storage device 920. However, the series of instructions can be stored on any conventional storage medium, such as a diskette, CD-ROM, ROM, EEPROM, flash memory, etc. Furthermore, the series of instructions need not be stored locally, and could be received from a remote storage device, such as a server on a network. The instructions are copied from the storage device, such as storage device 920, into memory 914 and then accessed and executed by processor 902.

An operating system manages and controls the operation of hardware system 900, including the input and output of data to and from software applications (not shown). The operating system and device drivers provide an interface between the software applications being executed on the system and the hardware components of the system. According to, the operating system is the LINUX operating system. However, the described implementations may be used with other conventional operating systems, such as the Windows® 95/98/NT/XP/Vista operating system, available from Microsoft Corporation of Redmond, Wash. Apple Macintosh Operating System, available from Apple Computer Inc. of Cupertino, Calif., UNIX operating systems, and the like. Of course, other implementations are possible. For example, the functionality of the pattern recognition system may be implemented by a plurality of server blades communicating over a backplane in a parallel, distributed processing architecture. The implementations discussed in this disclosure, however, are meant solely as examples, rather than an exhaustive set of possible implementations.

### E. Implementation Using Programmable Logic Circuit

As indicated above, the pattern recognition engine can be implemented as software on a standard processor or in connection with a semiconductor circuit including a programmable logic circuit, such as a field programmable gate array. In such an implementation, a driver layer (see FIG. 3, above) allows an application to pass commands (e.g., learn, recognize, etc.) to the FPGA, which implements the pattern recognition engine that maintains the knowledge maps and partitions. The benefits of the semiconductor version is the speed of pattern identification for larger knowledge maps (real-time or near real-time) and to off load the host processor. Also in some cases the semiconductor implementation can be used for embedded applications where a standard processor could not.

In one possible FPGA implementation, the pattern recognition engine is installed on a printed circuit board or PCB (which will normally be connected via an interconnect bus, e.g., PCI, PCI-Express, etc.). In one implementation, the FPGA unit is operative to receive an input or test vector, and return an identifier corresponding to a matching knowledge element or a category (and possibly opaque user data) associated with the matching knowledge element. In one implementation, each FPGA pattern recognition unit is a PCI device connected to a PCI bus of a host system.

Sensor reading or polling, sensor data processing and feature extraction operations could be offloaded to a co-processor or developed as an FPGA (or other programmable logic circuit) implementation and installed on a programmable logic circuit. Feature extraction is discussed above. Sensor data processing may involve one or more operations performed prior to feature extraction to condition the data set prior to feature extraction, such as pixel smoothing, peak shaving, frequency analysis, de-aliasing, and the like.

Furthermore, as discussed above, the comparison techniques (RBF, KNN, etc.), distance calculation algorithms (L1, LSup, Euclidian, etc.) can be user configurable and plugged in at runtime. In one programmable logic circuit implementation, the selected pluggable algorithms can be stored as a set of FPGA instructions (developed using VERILOG or other suitable SDK) and dynamically loaded into one or more logic units.

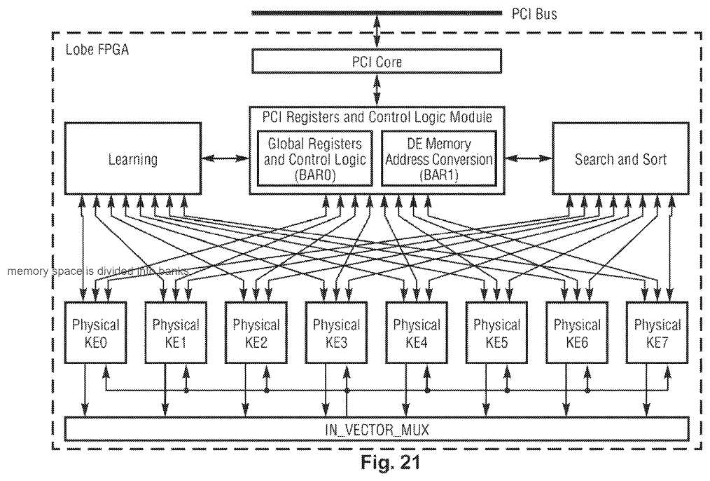

FIG. 21 below shows such an implementation. In this implementation, a Xilinx Spartan-3 family xc3s400 FPGA is configured to implement eight (8) physical knowledge element (KE) engines which interface with block memory to implement the total knowledge element count for the various vector widths. In this regard, the pattern recognition system could incorporate multiple FPGAs, similar to the FPGA described above, and control logic, possibly embodied in hardware or software, to coordinate operation of the multiple FPGAs.

The PCI Registers and control logic module includes registers that are used to configure the chip, and return the status of the chip. The module, in one implementation, includes a memory space for storing data (such as knowledge maps) and configuration information (such as partition information). In one implementation, the memory space is divided or allocated for different aspects of the pattern recognition system. A first memory space includes a set of registers, used in the learning and recognition phases, for the input vector, status information, configuration information, as well as information on matched knowledge elements (or setting of a newly created knowledge element in a learning operation). The matching knowledge element information can include a knowledge element identifier, an actual influence field, a minimum influence field, knowledge element status information (including whether it fired relative to an input vector), a category identifier, a partition, a distance value, and the like.

A second memory space provides for a knowledge element (KE) memory space, for virtual decision elements, allocated among the physical knowledge element engines. In one implementation, a second memory space is for knowledge element information. In one implementation, this memory space is divided into banks. Each bank is further divided into areas for knowledge element registers, and knowledge element vectors. One to all the banks may also include an area for storing one or more input vectors or portions of input vectors. Each virtual knowledge element, in one implementation, has its own set of registers in the knowledge element register, including for example, knowledge element identifiers, actual influence field, minimum influence field, partition identifier, category identifier, one or more distance field register that indicates the distance between an input vector and the corresponding learned vector of the virtual knowledge element Each bank of the second memory space also stores the learned vectors for each of the virtual knowledge elements allocated to it. The maximum number of learned vectors and knowledge elements in each bank is determined by the vector width. The control module, in one implementation, provides a memory address conversion for the knowledge element memory, as well as the de-multiplexer for read back. In one implementation, the second memory space also provides for storage of one or more input/test vectors. Of course, the memory space may be divided and arranged in a variety of configurations.

In one implementation, a learning module performs various learning operations, such as scanning all the existing knowledge elements, adjusting the existing knowledge element influence fields, setting category identifiers, finding the minimum distance to different category knowledge elements, and creating a new knowledge element if needed. In one implementation, the learning module can implement the learning functionality described above. The circuit may also include a multiplexer that provides a given test vector to the respective physical knowledge element engines. In one implementation, a physical knowledge element includes logic to compute the distance between a test vector and the learned vectors corresponding to the virtual knowledge elements to which the physical knowledge element has been assigned. In one implementation, each physical knowledge element engine is further operative to search for the minimum computed distance among the virtual knowledge elements to which it has been assigned. In one implementation, each physical knowledge element operates on an input vector to identify an assigned virtual knowledge element having the minimum distance to the input vector. In one implementation, the FPGA is a parallel processor in that the physical knowledge elements operate in parallel. In one implementation, each physical knowledge element computes a distance using an input vector and writes the computed distance to a distance register of the corresponding virtual knowledge element. The logic of the physical knowledge element is operative to return the knowledge element information corresponding to the virtual knowledge element having the minimum distance to the input vector. In one implementation, the control logic is operative to identify the virtual knowledge element having the overall minimum distance identified across the multiple physical knowledge element engines. In one implementation, the pattern recognition system provides results at each interconnect bus cycle. That is, on one interconnect bus clock cycle the input data vector or vectors are loaded across the bus and on the next bus cycle results are ready.

Given this bus clock cycle overhead, 100% parallelism in the knowledge elements is no longer required. Rather the pattern recognition system leverages the limited FPGA resources to implement the virtual knowledge elements. Using a virtual knowledge element approach, a plurality of physical knowledge element engines are implemented in the FPGA, each of which may relate to multiple virtual decision elements. Specific knowledge element contents would be stored in the FPGA memory to allow many hundreds of virtual knowledge elements to be implemented across a lesser number of physical knowledge element engines. These virtual KEs operate in a daisy chain or round-robin approach on the FPGA memory blocks to implement the total KE count coupled with the real, physical knowledge elements that are constructed in the FPGA's gate array area. Each virtual knowledge element has its own influence field. When learning causes a new virtual knowledge element to be allocated, the allocated virtual knowledge element number is returned. When a match occurs in the recognition phase, the firing virtual knowledge element number is returned. A 32-bit register can be implemented in each virtual knowledge element. This register can be written in learning phase. The value will be returned in the recognition phase unchanged. An application has full access to the virtual knowledge element memory space. The application can save the knowledge element network to hard disk and later reload the knowledge element network into the FPGA. The user can modify the knowledge element network according to their special need at any time except while a learning or recognition operation is in process. Through this interface knowledge elements can also be deleted if desired.

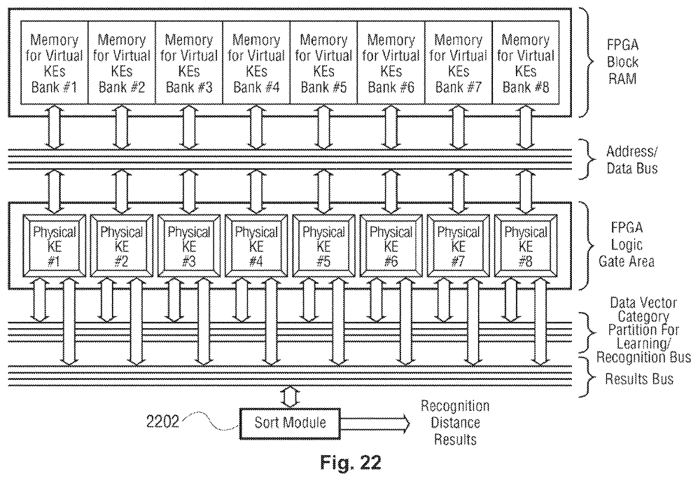

FIG. 22 below shows how these virtual knowledge elements relate to their physical counterparts in one possible FPGA implementation. FIG. 22 depicts a sort module 2202 used in some implementations of the FPGA. In a recognition operation, each physical knowledge element engine (Physical KE) measures the distance of all the matches for the virtual knowledge elements (Virtual KE) that it controls, and rank orders them by distance. This information is made available to a higher level functional circuit which combines the results of the physical knowledge element engines to create the final overall result.

Additionally, in the FPGA implementation, the pattern recognition system can be implemented using a pipeline approach as many data vectors can be loaded in a single interconnect bus clock cycle thus further speeding the overall result time for many data vectors needing identification. That is, the pipeline may increase the effective speed of recognition performed by the FPGA.

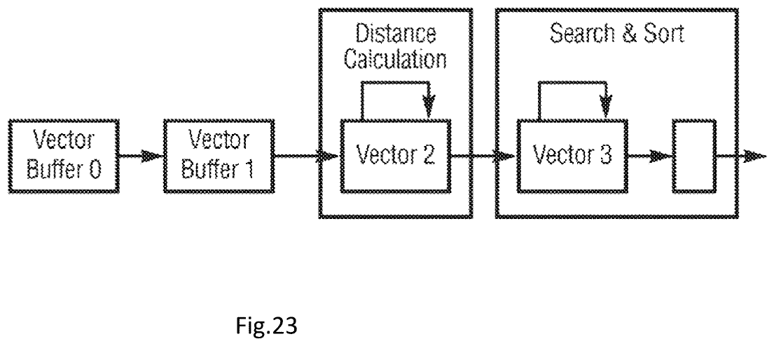

As shown in FIG. 23, the pipeline has 3 stages: 1) search and sort; 2) distance calculation and 3) vector buffers. Four input vectors can be stored in the FPGA. The vectors are processed first in-first out. When the Buffer Ready flag is set, it means that vector buffer 0 is empty. The user (e.g., the programmer) can write a vector into the FPGA. The input vector written into the FPGA, in one implementation, is written into buffer 0. After the last byte of the vector is written, vector buffer 0 will be locked (not ready). When the next stage is empty, the vector will move forward, and Buffer 0 will be empty (ready) again. Writing a vector into the FPGA while buffer 0 is not ready will cause an error. Setting NEXT_VECTOR flag will push the vector at the search and sort stage out of the pipeline. The other vectors in the pipeline will move forward.

The RESET flag can be used to remove all the vectors in the FPGA. With this mechanism, two vectors can be processed at same time, where a distance calculation is performed relative to one input vector, while a search and sort operation can be performed relative to a second input vector. In addition, while waiting for the result, software can write other vectors into the FPGA. In addition, while waiting for the minimum distance to be read out, a next minimum distance can be searched.

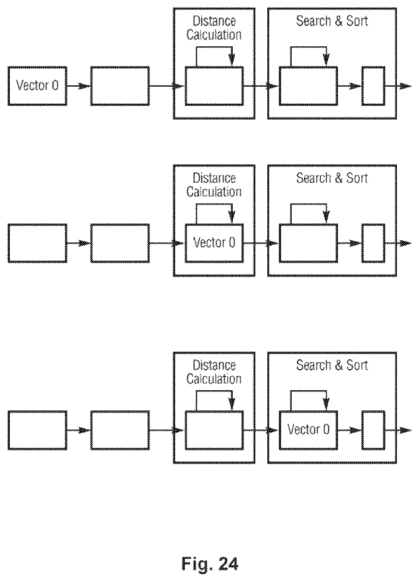

For the application software, reading results and writing vectors can be performed in two separate threads. When the Buffer Ready is set, the application can write a vector into the FPGA. When the Ready flag is set, the application can read the result out. Read knowledge element number and distance will trigger hardware to search for the next matched knowledge element. To process the next vector, the application can set the NEXT_VECTOR flag. The first input vector just flows through to the end and sets the status flag when the results are ready. This is shown in FIG. 24.

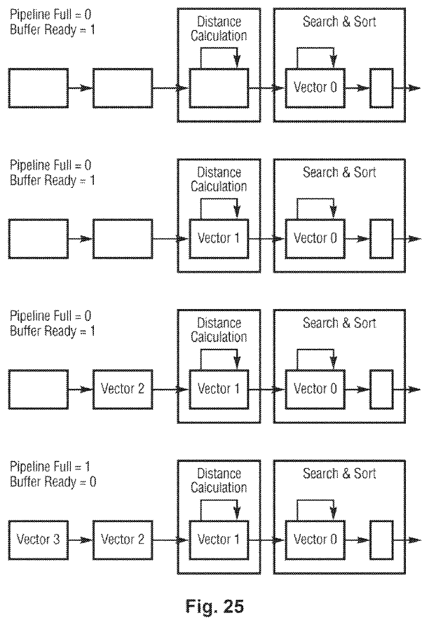

When the application needs to process vectors one by one, the user can write the vector in, and wait for the result. After this vector has been processed, the application can set the NEXT_VECTOR flag to remove this vector from the pipeline, and then write the next vector in. The next vector will flow through to the end just like the first vector. If the user doesn't set the NEXT_VECTOR flag to remove the front end vector, the second input vector will flow through to the distance calculation stage, and the third vector will wait in the vector buffer 1. They will not push the first vector out, as illustrated in FIG. 25.

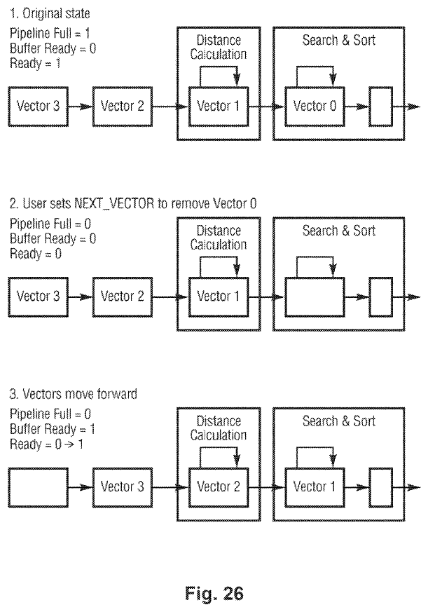

When the pipeline is full, the application sets the NEXT_CONFIG flag to remove the front end vector out of the pipeline before writing another vector in. All the other vectors will move forward. For example, as shown in FIG. 26, vector 0 will be pushed out, vector 1 will move into search and sort stage, the vector in buffer 1 will move to the distance calculation stage. Buffer 0 will be empty. The Buffer Ready flag will be set again.

To recapitulate with respect to pipelining, vectors can be written into the vector buffer when vector buffer is empty. When the distance calculation stage is free, the vector in the vector buffer 1 will be moved forward, and vector buffer 1 will be left free for next vector. When the distance calculation is finished, and the search & sort stage is free, the vector will be moved forward (actually it will be discarded). The minimum distance will be searched, and copied to the output buffer. Next the minimum distance will be searched while waiting for the minimum distance to be read. The vector at Search & Sort stage will be discarded when software writes another vector into the FPGA.

As is relevant to the partitions discussed above, given the structure of the FPGA block RAM according to one possible implementation, four different vector widths (32/64/128/256—bytes) can be supported, which in turn, result in four different virtual KE counts (672/400/224/112). Thus, an application can choose the width and count most appropriate to the task at hand. Of course, other FPGA implementation may allow for different vector widths and

Finally, physical knowledge elements might be loaded with different distance calculation algorithms for different requirements. Thus, the FPGA can be configured to allow all physical knowledge elements to use the same recognition math or algorithm. Alternatively, each physical knowledge element can be configured to use a different math, e.g., L1 or LSUP. Or further still, the math for the physical knowledge elements can be swapped in/out based on the partition chosen for pattern identification and the partition's associated “math” requirements.

Some implementations of classification engines described herein are configured to monitor a series of input vectors, and with minimal computation resources, construct a model of the data. The low computational power required in some implementations for establishing the data model enables the system to operate in real-time using low-cost processors or other suitable hardware. Once the data model is established, the classification engine classifies new incoming input vectors as being a member of a class or not a member of the class. In one specific implementation input data may be classified as being a member of one of a plurality of classes, or as not being a member of any one of the existing classes. In addition to determining the class to which the input belongs, the system can determine a measurement for the probability that the classification was accurate, as well as provide a means to trace the input vectors that contributed to the classification.

In some implementations, the new incoming input vector dynamically modifies the data model to ensure that the data model is continuously and dynamically updated. The system then classifies whether the received signal was reflected by a specific object. The system also provides the probability with which the identification was determined. In addition, the system provides the previous input data that contributed to the classification.

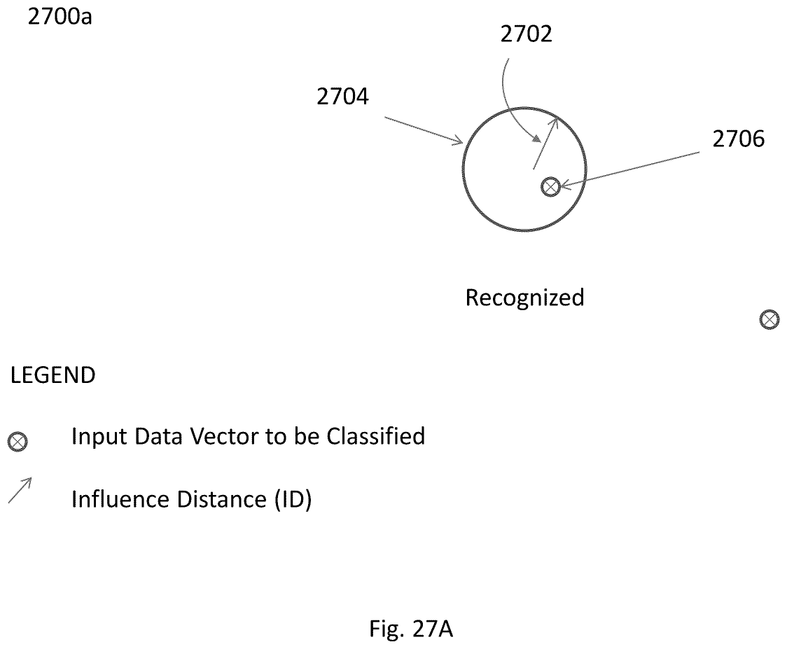

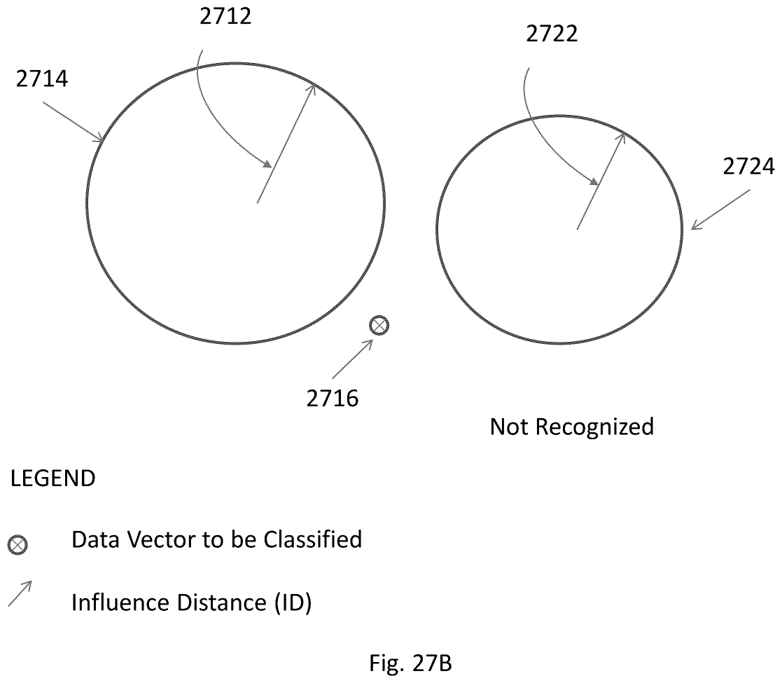

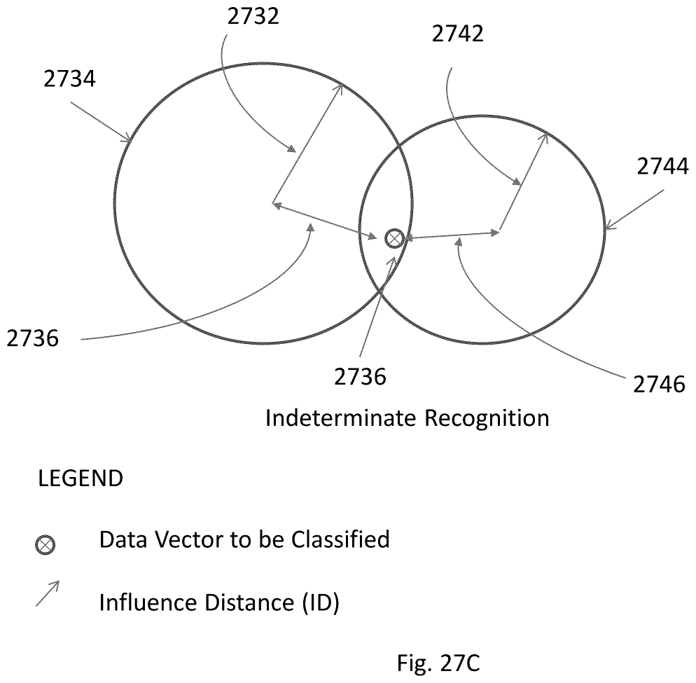

FIGS. 27A-C expand on the graphical illustration of FIG. 8 and provide a more detailed explanation of the operation of the classification engine according to some implementations. Referring to FIG. 27A, when the new input vector 2706 falls within the sphere 2704 defined by a specific ID 2702, the method classifies the input vector as being a member of the sphere 2704 and in accordance with one specific implementation the method assigns a probability value of 1 to its determination.

Referring to FIG. 27B, when the input vector 2716 falls outside of the spheres 2714 and 2724 defined by specific IDs 2712 and 2722, the method classifies the input vector 2716 as not being a member of either sphere 2714 or sphere 2724, and in accordance with one specific implementation the method assigns a probability value of 1 to its determination.

Referring to FIG. 27C, when the input vector 2736 falls within both spheres 2734 and 2744 defined by specific IDs 2732 and 2742, the method classifies the scenario as an intermediate recognition of input vector 2736 as being a member of both spheres 2734 and sphere 2744. In accordance with one specific implementation the method assigns a first probability P1 to the classification that labels the input vector 2736 as being a member of the sphere 2734, and a second probability P2 to the classification that labels the input vector 2736 as being a member of the sphere 2744.

In accordance with one specific implementation the method determines probabilities P1 and P2 by examining the distances of the input vector 2736 to spheres 2734 and 2744; specifically the distance d1, 2736, and distance d2, 2746. In accordance with yet another specific implementation the system also factors in the size of each sphere as well as the number of hits each sphere experienced in a predetermined time window.

$${P}_{i} = f ( {d}_{i} , {h}_{i} , {ID}_{i} , {W}_{i} ) / ( f ( {d}_{1} , {h}_{1} , {ID}_{1} , {W}_{1} ) + f ( {d}_{2} , {h}_{2} , {ID}_{2} , {W}_{2} ) ) \qquad Equ . 1$$

Where:
Pᵢ— probability of classifying input vector as a member of i^{th} sphere
fᵢ—function of distance of: input vector to an i^{th} sphere and sphere parameters
dᵢ—distance of input vector to i^{th} KE sphere
hᵢ—number of input vectors that “hit” i^{th} KE sphere in a predetermined time window
IDᵢ—size of the influence distance of the i^{th} KE sphere
Wᵢ—weighting function of the i^{th} KE as explained in greater details below.

Equ. 2a-c provide a few non limiting examples of the probability function of Equ. 1. Equ. 2a provides an example of a simple probability function which depends only on the distance of the input vector to i^{th} KE sphere:

$$\begin{matrix}f ( d , ID ) = ID / d & for d > ID \\ 1 & otherwise\end{matrix} \qquad Equ . 2 a$$

Where:
ID—size of the influence distance of the i^{th} KE sphere
d—distance of input vector to i^{th} KE sphere

Equ. 2b provides an example of a simple probability function which depends on the distance of the input vector to i^{th} KE sphere and the hit count of the specific KE:

$$\begin{matrix}f ( d , ID ) = ( ID / d ) * ( h / H ) & for d > ID \\ 1 & otherwise\end{matrix} \qquad Equ . 2 b$$

Where:
ID—size of the influence distance of the i^{th} KE sphere
d—distance of input vector to i^{th} KE sphere
h—number of input vectors that “hit” the KE sphere in a predetermined time window
H—total hit count of all KEs (either in the overall knowledge map or the sum of hits of KEs within the search distance

Similar probability functions can be used when additional parameters are considered in the process of determining the probability function of Equ 1.

In a more general case when the input vector falls within the vicinity of multiple IDs, the probability that the input vector should be classified as being a member of any specific sphere is easily extended to

$${P}_{i} = f ( {d}_{i} , {h}_{i} , {ID}_{i} , {W}_{i} ) / {\sum }_{n = 1}^{N} f ( {d}_{n} , {h}_{n} , {ID}_{n} , {W}_{n} ) \qquad Equ . 3$$

Where
N—the number of spheres in the neighborhood of the input vector

While Equ. 3 describes the probability as a function of the distance of input vector to i^{th} KE sphere, the number of input vectors that “hit” i^{th} KE sphere in a predetermined time window, the size of the influence distance of the i^{th} KE sphere, the weighting function of the i^{th} KE sphere, and the quality function of the i^{th} KE, it should be understood that these parameters are just being brought for sake of illustration. Specific implementations may utilize more parameter, less parameters, or a different set of parameters.

In accordance with one specific implementation, the number N is limited to the k spheres (KEs) that are closest to the input vector. In accordance with another implementation, the number N is limited to include only the M spheres (KEs) that are no further than a predetermined distance D. In accordance with another implementation, all spheres (KEs) in the knowledge map may be considered.

Equ. 4 determines one possible weighting function W of a knowledge element (KE). Other weighting functions of knowledge element related information may be used.

In one implementation, the weight (W) of a KE is defined by:

$${W}_{i} = ( ID - avg\_dist \_of \_KE ’ s\_hits to {KE}_{i} ) / ID \qquad Equ . 4 a$$

$${W}_{i} = 1 - ( avg\_dist \_of \_KE ’ s\_hits to {KE}_{i} ) / ID \qquad Equ . 4 b$$

Where:
Wᵢ—weight of KEᵢ
ID—Influence Distance of the i^{th} KE
avg_dist_of_KE's_hits to KEᵢ—the average distance between the input vectors that fell within the ID of KEᵢ and KEᵢ

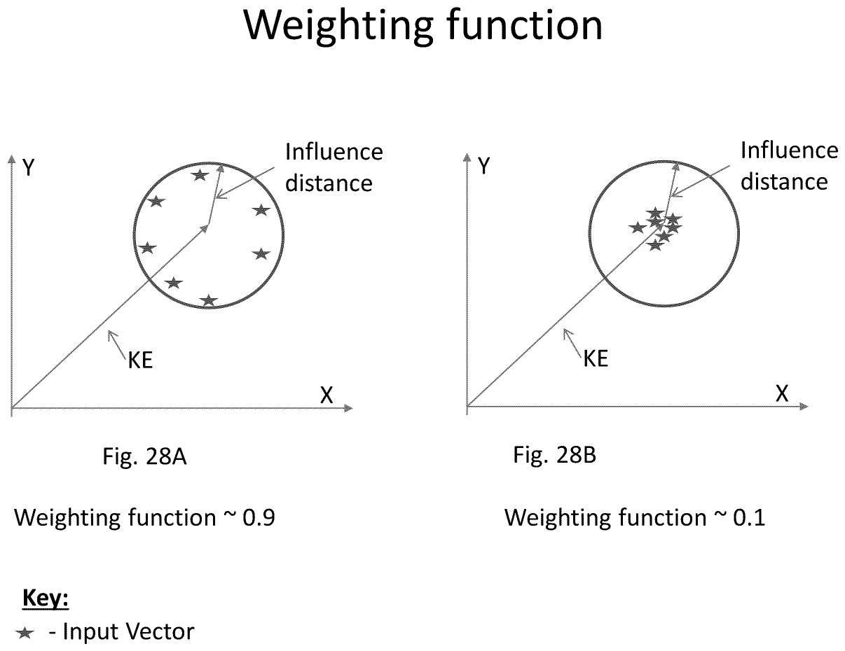

Referring to FIGS. 28A-B, the weight value is defined as a normalized average distance between a KE and the input vectors that are within the influence distance of that vector. FIGS. 28A-B illustrate two scenarios. FIG. 28A illustrates a first scenario wherein the input vectors reside close to the boundaries of the influence distance of a KE. In this case the input vectors are at a distance which is substantially similar to the influence distance of the KE. Normalizing the average distance by the size of the value of the influence distance results in a number close to 1, e.g., 0.9. FIG. 28B illustrates a second scenario wherein the input vectors reside close to the center of the KE and as such the average distance between each input vector and the KE is close to zero. Normalizing the average distance by the influence distance results in a number close to zero, e.g., 0.1. In general, the weight of a KE assumes values within [0-1]. For some applications, the inverse of this weighting property may be used, or such a weighting function may not be used at all.

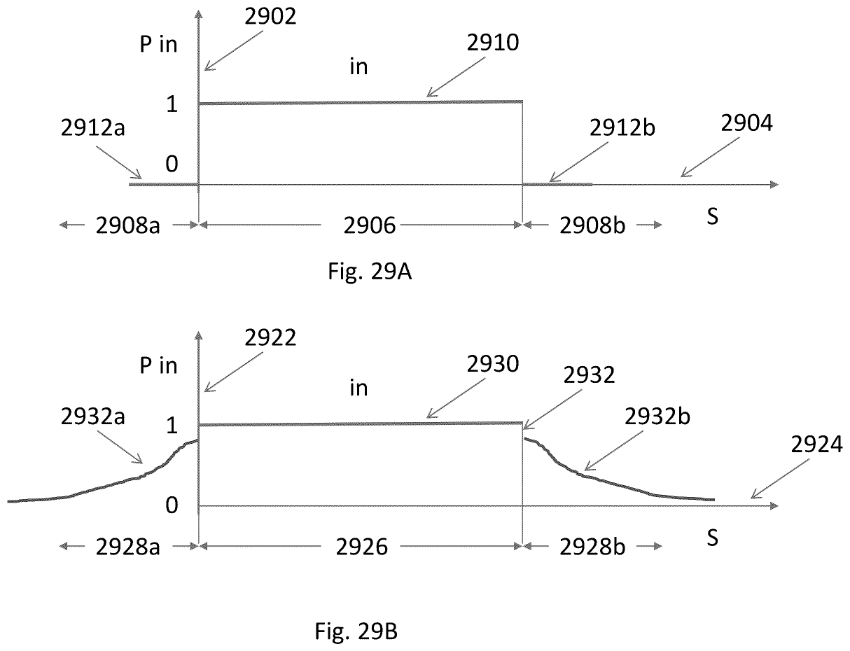

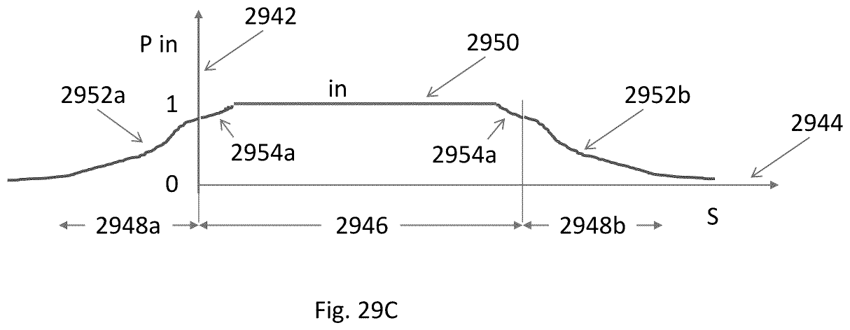

FIGS. 29A-C illustrate the difference between previous classification methods and a classification method performed according to some implementations. FIG. 29A provides a simplified illustration of classification of an input vector within the space S, 2904. The resulting probability is denoted on the P axis 2902. When a vector falls within a KE domain 2906, the method indicates that the vector corresponds to the input belonging to (or identified as being within) the KE with probability 1, 2910. However, when the input vector falls outside the KE in regions 2908a or 2908b, the method indicates that the input vector corresponds to the input belonging to (or identified as being within) the KE with probability 0, 2912a or 2912b.

In some implementations, when the boundary is clear such as being inside a bottle or out of a bottle, such classification is adequate. However when the classification is more fuzzy, or in our bottle example when the KEs do not properly cover the whole inner space of the bottle, a probabilistic definition may be advantageous.

Referring to FIG. 29B, a simplified illustration of probabilistic classification of an input vector within the space S, 2924, is provided. The resulting probability is denoted on the P axis 2922. When a vector falls within a KE domain 2926, the method indicates that the vector corresponds to the input belonging to (or identified as being within) the KE with probability 1, 2930. However, when the input vector falls outside the KE in regions 2928a or 2928b, the method indicates that the input vector corresponds to the input belonging to (or identified as being within) the KE with variable probability greater than 0, 2932a or 2932b per Equ. 3 described above.

As can be seen in FIG. 29B, when there are different KEs that define different sets of classes in the vicinity of the first KE, the probability at the boundary experiences a step drop such as the one illustrated by 2932.

In accordance with yet another implementation the step function 2932 is smoothed by reducing the probability within the class. Referring to FIG. 29C, a simplified illustration of smoothed probabilistic classification of an input vector within the space S, 2944, is provided. The resulting probability is denoted on the P axis 2942. When a vector falls within a KE domain 2946, the method indicates that the vector corresponds to the input belonging to (or identified as being within) the KE with probability 1, 2930, in most of the domain 2450. However, when the input vector falls outside the KE in regions 2948a or 2948b, the method indicates that the input vector corresponds to the input belonging to (or identified as being within) the KE with variable probability 2952a or 2952b per Equ. 3 described above. The method determines a region within the center of domain 2946 for which the method determines that the input vector is indicative of being within the KE is with probability 1. However, for the region closer to the boundary of the KE sphere, the method determines a probability smaller than 1 that helps smooth the probability curve, by employing smoothed probabilities 2954a and 2954b.

The size of the boundary regions and the smoothed probability functions may also be functions of di, hi, IDi, and Wi.

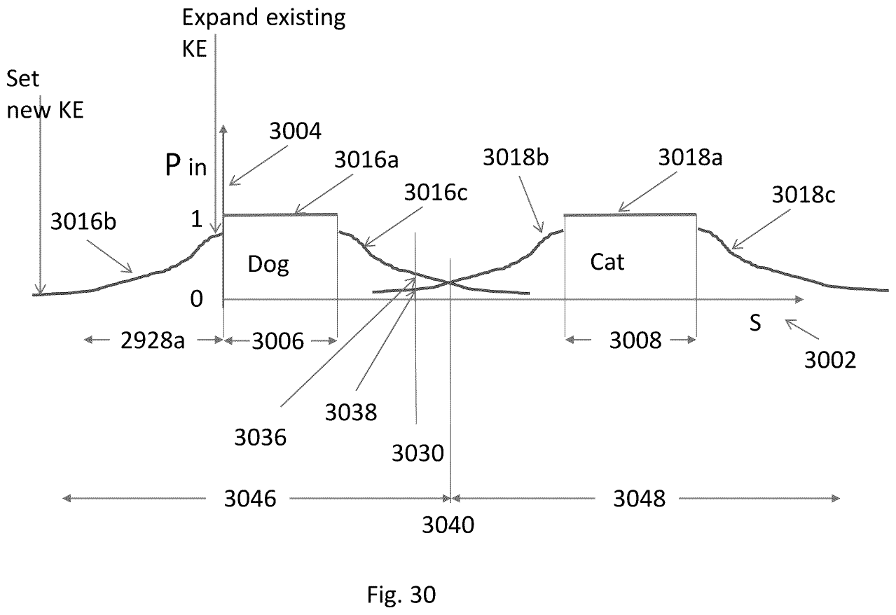

FIG. 30 provides a simplified illustration of a method to determine a plane separating between neighboring KEs.

The multi-dimensional vector space (S) is simplified and illustrated by the x axis 3002. The probability that an input vector is within a KE (Pᵢₙ) is illustrated along the y axis 3004. As illustrated in FIG. 30, when an input vector falls within a specific KE such as KE 3006 or KE 3008, the system model identifies the input vector as being within the KE with probability of 1. As illustrated in FIG. 30, an input vector is said to be within KE 3006 with probability 1, 3016a, and similarly, an input vector is said to be within KE 3008 with probability 1, 3018a.

However when an input vector falls outside KEs, the method determines a probabilistic classification defining the probability that an input vector should be classified as a member of a neighboring KE. As illustrated in FIG. 30, when the input vector falls outside KEs, the method determines that it is within KE 3006 with probability Pᵢₙ, 3016b or 3016c, and similarly, an input vector is said to be within KE 3008 with probability Pᵢₙ, 3018b or 3018c.

In accordance with some implementations, when a vector falls outside a KE, the method may report the probabilities that the vector should be classified as a member of the neighboring KEs. As illustrated in FIG. 30, when the input vector falls outside KEs such as input vector 3030, the method determines that it is within KE 3006 with probability Pᵢₙ 3036, and within KE 3008 with probability Pᵢₙ 3038.

In one specific implementation when the input vector falls outside KEs, the method may provide the top k probabilities that the input vector belongs to each one of the P neighboring classes/KEs. In accordance with another special implementation the method classifies the input vector as being a member of the class for which it is determined that it has the highest probability of belonging to.

In accordance with some other implementations, the special value of the input vector when the input vector falls within the space S in a place where Pᵢₙ 3036=Pᵢₙ 3038 defines a multidimensional plane separating between KEs as illustrated in FIG. 30, when the input vector assumes a value that results in the classification probabilities 3036 and 3038 to be equal such as input vector 3040 the method may classify vectors within the space 3036 as belonging to KE 3006 and input vectors within the space 3038 as belonging to KE 3008. The specific value of the input vector 3040 represents a single dimension plane within the space S. The dimension of the plane corresponds to the dimension of the input vector.

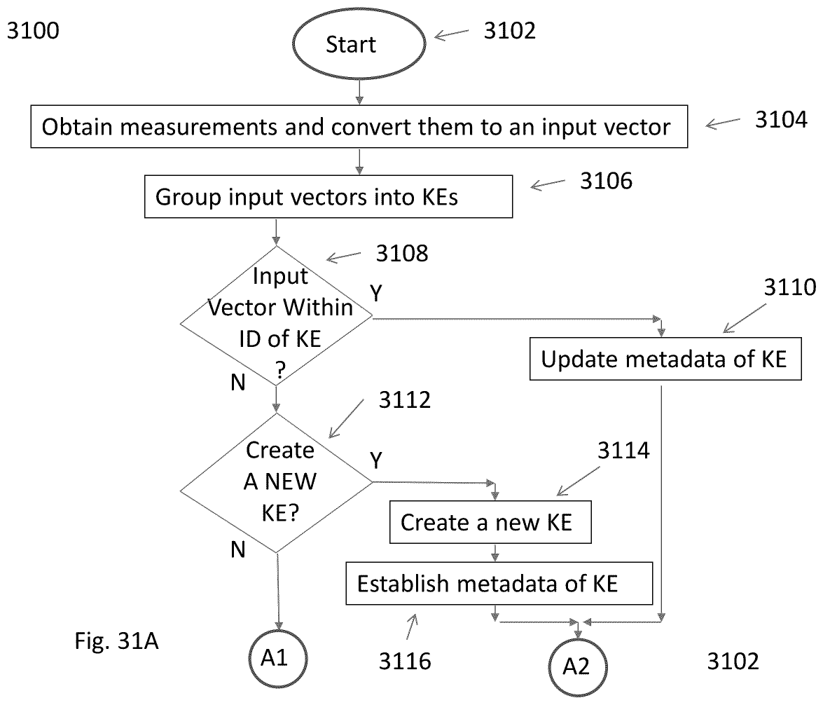

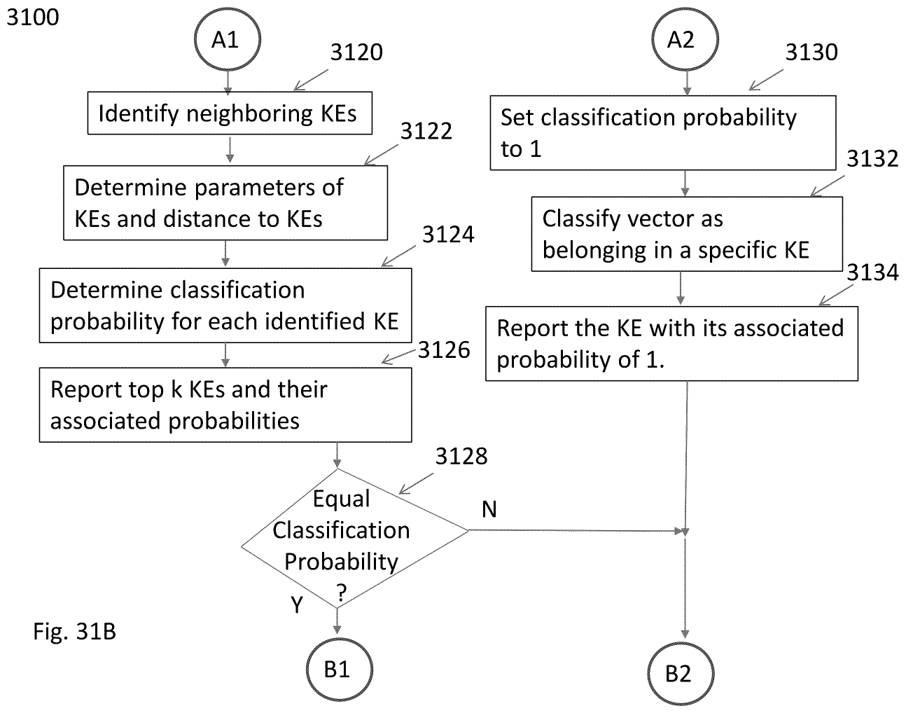

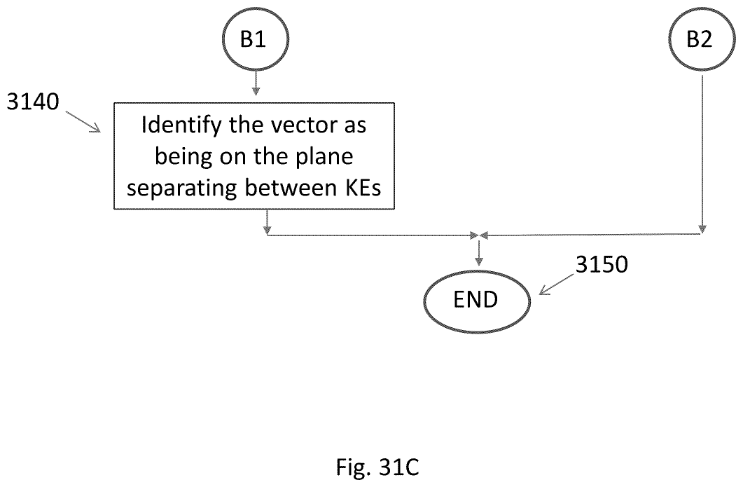

FIGS. 31A-C provide a flowchart illustrating a method for determining and utilizing a probabilistic classification. The method starts at operation 3102 and proceeds to operation 3104 where measurements of a process are taken and converted into an input vector. In operation 3106 input vectors are grouped in a supervised or unsupervised machine learning process into knowledge elements (KEs). Operation 3106 is utilized during the phase known as initial learning or classification model establishment. This operation may be skipped after the initial classification model is established.

Once the initial classification model is established, operation 3108 examines an input vector and determines whether it falls within the influence distance ID of a specific KE. If the input vector falls within a specific KE, the method proceeds to operation 3110 where the metadata of the specific KE is updated. The method proceeds via connector A2 to operation 3130. However if operation 3108 determines that the input vector does not fall within the ID of a specific KE, the method proceeds to operation 3112 where it is determined whether a new KE should be created. If the operation determines that a new KE should be created, the method proceeds to operation 3114 where a new KE is established and the metadata for the new KE is established in operation 3116. The method proceeds via a connecting operation A2 to operation 3130.

However if operation 3112 determines that a new KE should not be created, the method proceeds via connector A1 to operation 3120 where the neighboring KE of the input vector are identified. In operation 3122 the various parameters of the neighboring KE are determined including the distance between the input vector and each one of the neighboring KE. Operation 3124 uses the above parameters to determine the probabilistic classification that the input vector is a member of each one of the neighboring KEs. The top KEs for which the classification probability is the highest are identified and reported in operation 3126.

Operation 3128 determines whether two or more of the classification probabilities are substantially the same (or equal). If the operation identifies two or more KEs for which the probabilistic classification is the same, the method continues via connector B1 to operation 3140. Operation 3140 identifies the vector as being on the boundary plane that separates between the two KEs for which the classification probabilities are substantially the same. The process ends in operation 3150.

However if operation 3128 determines that there are no identical (or substantially identical) classification probabilities, the method proceeds via connecting operator B2 and ends in operator 3150.

Returning to connecting operator A2, the method proceeds to operator 3130 where the classification probability is set to 1 and the input vector is identified in operation 3132 as being well within the specific KE. The classification of the input vector as belonging to the specific KE with probability of 1 is reported in operation 3134. The method proceeds via connecting operator B2 and ends in operator 3150.

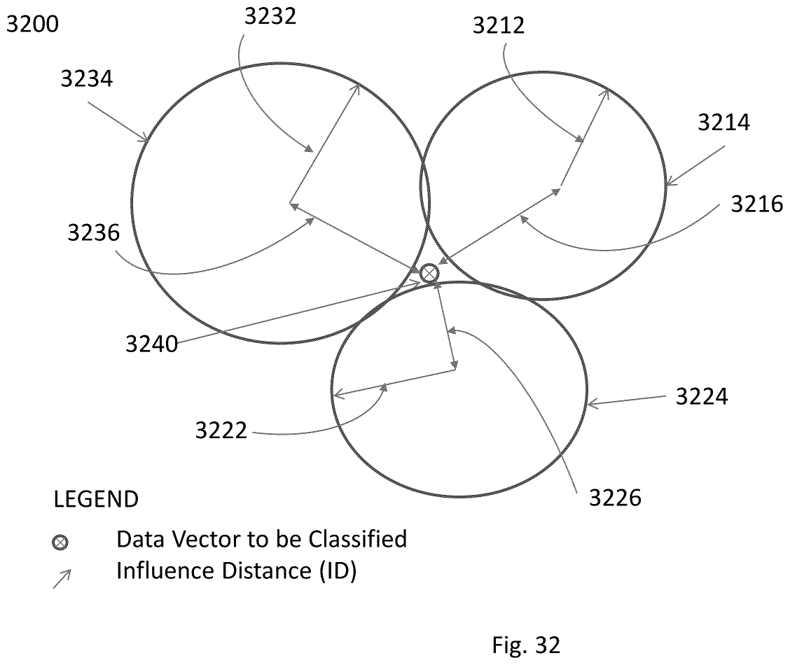

One of the benefits of the method described above is illustrated in FIG. 32.

Referring to FIG. 32, three KE spheres, 3214, 3224, and 3234 are illustrated with respective IDs 3212, 3222, and 3232. In this example, all three KE belong to the same class. Said differently, any input vector that falls within the sphere of these KEs is indicative that it belongs to the class represented by these KEs. Similarly input vectors that fall out of these KEs are indicative that the input vector represents an entity that does not belong to the class of these KEs. A new input vector 3240 may fall in a space between the KEs 3214, 3224, and 3234 with distances of 3216, 3226, and 3236 to the centroids of these three KE spheres. Using existing method, the system may classify the input vector as not belonging to the same class as KEs 3214, 3224, and 3234. However using the probabilistic method described above and specifically using Equ. 3, the method determines that the input vector belongs to the class of KE 3014 with probability P1, to the class of KE 3224 with probability of P2 and to the class of KE 3234 with probability of P3, where:

$${P}_{1} = f ( {d}_{1} , {h}_{1} , {ID}_{1} , {W}_{1} ) / {\sum }_{n = 1}^{3} f ( {d}_{n} , {h}_{n} , {ID}_{n} , {W}_{n} ) \qquad Equ . 5 a$$

$${P}_{2} = f ( {d}_{2} , {h}_{2} , {ID}_{2} , {W}_{2} ) / {\sum }_{n = 1}^{3} f ( {d}_{n} , {h}_{n} , {ID}_{n} , {W}_{n} ) \qquad Equ . 5 b$$

$${P}_{3} = f ( {d}_{3} , {h}_{3} , {ID}_{3} , {W}_{3} ) / {\sum }_{n = 1}^{3} f ( {d}_{n} , {h}_{n} , {ID}_{n} , {W}_{n} ) \qquad Equ . 5 c$$

Since the three KEs represent the same class, the probabilistic method determines that the probability that the input vector represent the same class as these three KE is

$$P = P 1 + P 2 + P 3 = {\sum }_{n = 1}^{3} f ( {d}_{n} , {h}_{n} , {ID}_{n} , {W}_{n} , {Q}_{n} ) / {\sum }_{n = 1}^{3} f ( {d}_{n} , {h}_{n} , {ID}_{n} , {W}_{n} , {Q}_{n} ) = 1. \qquad Equ . 5 d$$

Another aspect of the method is that in some applications it can reduce the computational complexity by introducing a multistage classification method and facilitates the selection of the parameters (and the number of parameters) required for making a classification.

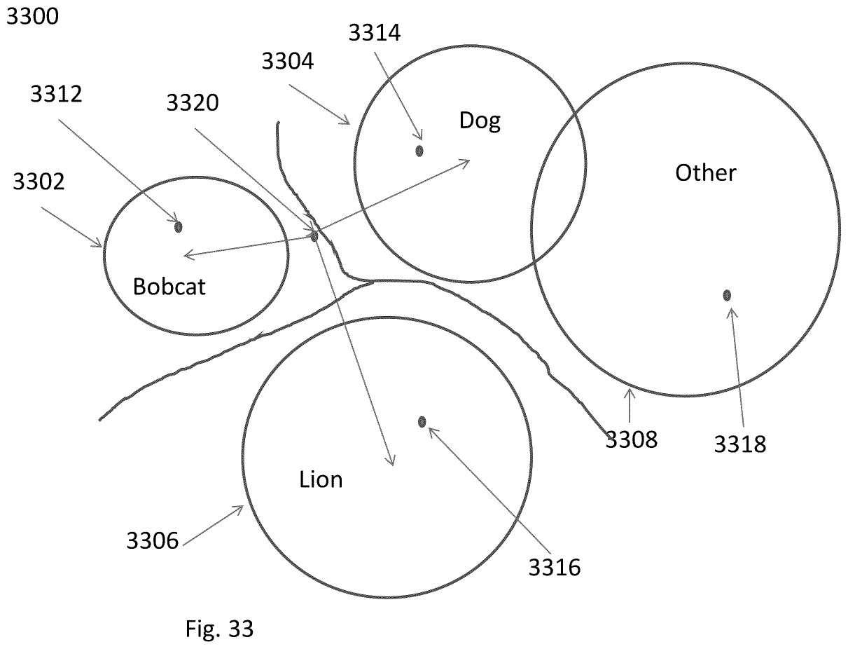

Referring to FIG. 33, assume that a system needs to classify an input vector as belonging to a class of “bobcat”, “dog”, “lion”, “other”, etc. Traditional RNN classification methods train a classification model of dimension N and examine its performance. As part of the training phase, the user may vary the size of the dimension N multiple times, each time attempting to train the model with input vector of different sizes and examining the training results on another sample of input vectors. For example, after multiple tries, the user may determine that a vector of dimension of 37 is required and thus maintain a single model that requires all input data to be processed with vectors of dimension value of e.g., 37.

In accordance with some implementations, the training method starts with a first stage/phase of training wherein only k dimensions (k<N) are used. Such model may be able to classify properly a large number of input vectors that fall within the determined KE spheres such as spheres 3302, 3304, 3306, and 3308. For example, input vectors such as vectors 3312, 3314, 3316, and 3318 could be properly classified using an input vector and a suitable system model of a lower dimension k, e.g., k=20.

However when during the training process the system encounters vectors which could not be classified using the simplified system model, e.g., input vector 3320, the system first determines the neighboring classes of ambiguity. For example, the input vector 3320 has the ambiguity of whether it represents a class of “bobcat”, “dog”, or “lion”. The fact that the system identifies the classes of ambiguity may help determine new parameter that could help with classifying the input vector as belonging to one of these classes. For example, the system may add a measure of the ration between the length of the tail and the body size which can help clarify the ambiguity between a lion and a bobcat. Staying with our example, the user may construct first a model with vectors of size k and classify most of the input vectors properly. Then for the input vectors that fall in between KEs, e.g., lion and a bobcat, develop another model with input vectors of length k+1, e.g., k=21, which includes the ration between the length of the tail and the body size as the added new dimension.

In operation, the system starts with input vectors of lower dimension such as k. If the input vector cannot be characterized, the neighboring classes are identified. Based on the identified classes, the method augments the input vector with specific parameters suitable for providing better classification among the identified classes. The augmented vector is then run against the suitable model resulting in an improved classification with a lower computational complexity.

It should be noted that in some cases, the system may identify parameters which actually do not contribute to making the second/next stage classification. These parameters may be dropped resulting actually in a smaller vector dimension. For example, the system may determine that since all of the lions and bobcats have the same eye color this parameter may be dropped and not used in the second phase of the processing, thus reducing further the computational complexity.

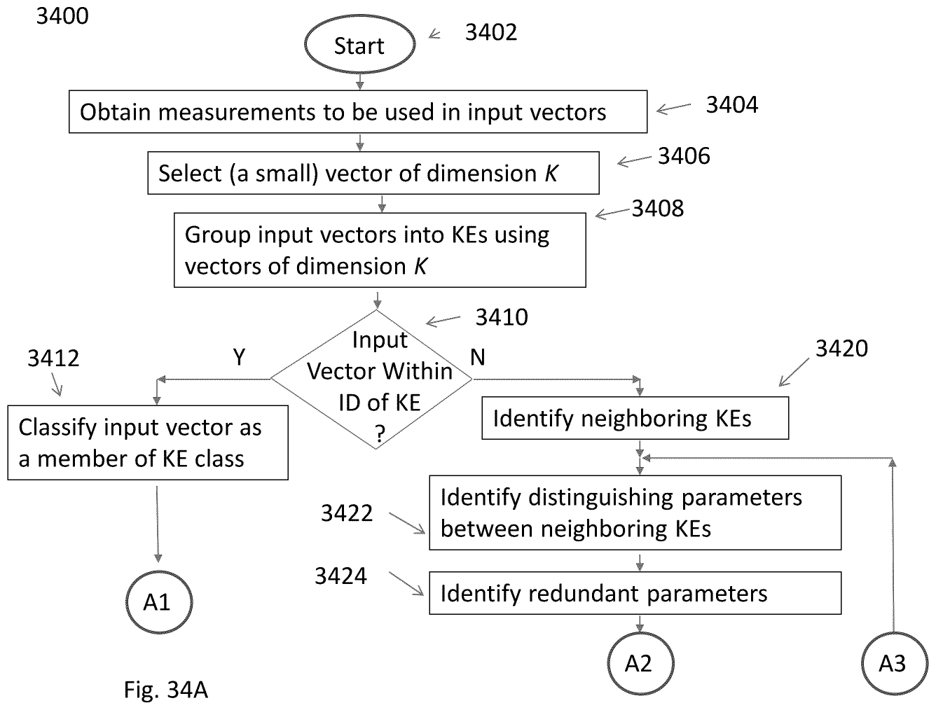

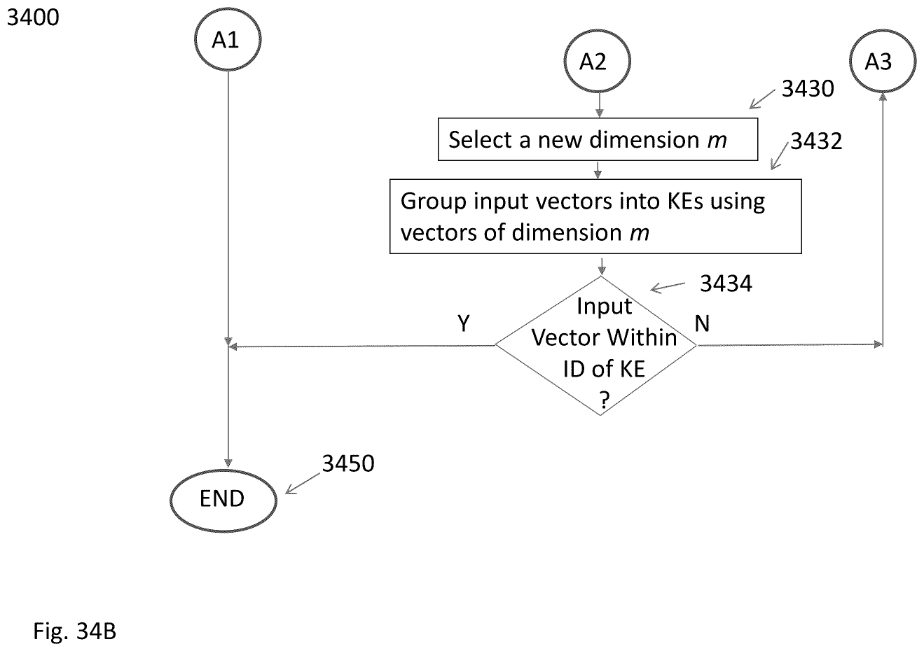

FIGS. 34A-B provide a flowchart 3400 illustrating training of a classification model for a multistage classification system. The advantage of this method is a reduced computational complexity.

The method starts in operation 3402 and proceeds to operation 3404 where measurements are obtained for construction of input vectors. Operation 3406 selects a subset of the parameters collected in operation 3404. For example only a subset of k out of N (k<N) collected parameters are selected and used in operation 3408 to construct input vectors. The method constructs a classification model using a process that was described above. As part of constructing the classification model, multiple KEs are identified.

Operation 3410 examines whether an input vector falls within the ID of any specific KE. This event is identified either because an input vector falls within the ID sphere of an existing KE or because the algorithm constructs a new KE based on the input vector. If the operation identifies the input vector as a member of an existing KE or a new KE, operation 3412 identifies the input vector as a member of this KE, for example by updating the associated metadata. The method proceeds via a connector operation A1 and ends in operation 3450.

However if operation 3410 determines that the input vector is not within the ID of any KE, the method proceeds to operation 3420 where the neighboring KEs of that input vector are determined. In operation 3422 parameters that could help classify with higher probability the input vector as a member of one of the neighboring KEs are selected. Similarly operation 3424 identifies parameters that do not contribute to the distinction between the neighboring KE may be removed. For example, if the classification process leading to this stage was not able to distinguish between a mountain lion and a bobcat, operation 3422 may identify the ratio between the length of the tail and the size of the body as a parameter that needs to be added. Similarly, operation 3424 may identify the number of legs the object has as a redundant parameter that does not need to be used in the next classification phase.

The method proceeds via a connection operation A2 to operation 3430 where based on the number of added parameters (in operation 3422) and the number of removed parameters (in operation 3424) a new dimension m is selected.

$$m = k + number of added parameters - number of subtracted parameters \qquad Equ . 6$$

Operation 3432 new input vector, of dimension m, is used to construct a new classification model. This classification model is stored as a model to distinguish measurements and classify them as members of one of the neighboring KEs identified in operation 3420. For example, the new classification model is tagged as a model to distinguish between, e.g., bobcats and mountain lions.

Operation 3434 examines the accuracy of this model. If this model performs properly, e.g., it distinguishes properly between bobcats and mountain lions, the method ends in operation 3450. However if the operation does not perform properly, the method loops back via connector operation A3 to operation 3422 where new parameters are chosen with an attempt to make a better distinction/classification of measured parameters as being members of a specific class.

As a result of utilizing the training input vectors the process generates a first stage classification model which can roughly classify the measurements into broad classes. Then the process utilizes additional parameters (while potentially dropping other parameters) for constructing finer classification models. These models can then be used for finer classification within each one of the rough classes. For example the rough model can determine whether the object is a feline or a canine. Then the finer classifications models help determine within each one of these classes whether the input measurements are indicative of any specific member within the rough class. It should be noted that while for sake of simplicity the discussion above was about a two stage classification method, the algorithm contemplates a broader multistage method wherein each one of the fine classification models can be a parent of yet another group of finer classification models.

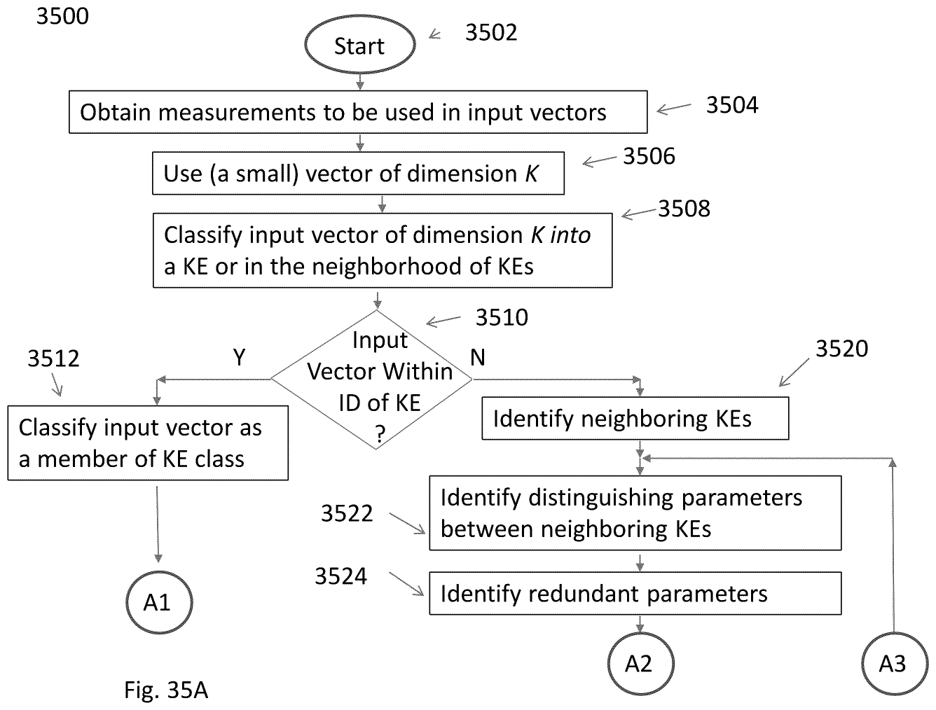

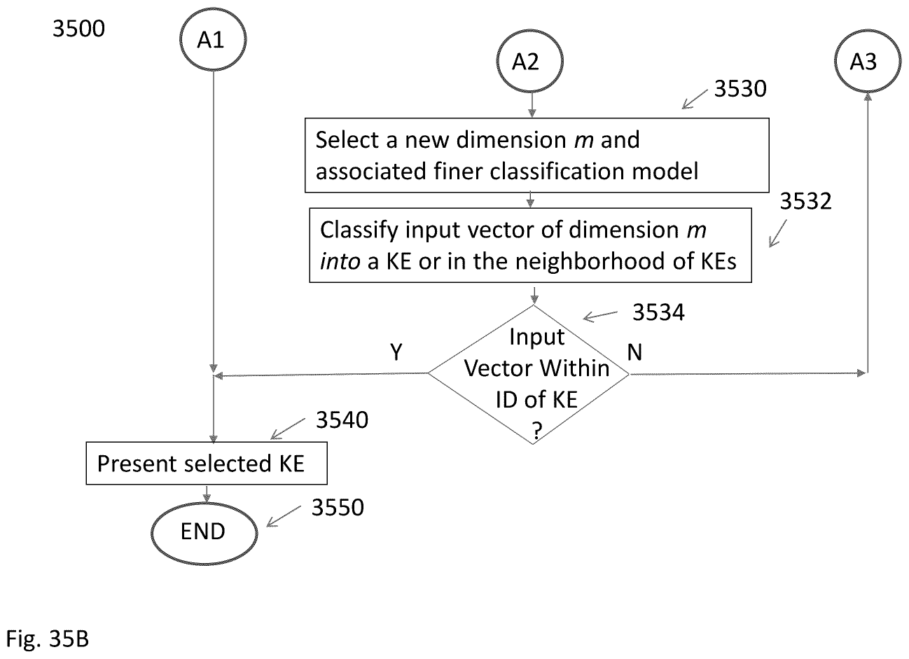

FIGS. 35A-B provide a flowchart illustrating the use of a multistage classification model. The advantage of this method is a reduced computational complexity.

The method starts in operation 3502 and proceeds to operation 3504 where measurements are obtained for construction of input vectors. Operation 3506 uses a subset of the parameters collected in operation 3504. These are the same parameters which were used in operation 3404 for constructing the associated classification model. Operation 3508 uses the associated model to classify input vectors. An input vector is classified as being in a specific class if the vector falls within the sphere of a given KE.

Operation 3510 examines whether an input vector falls within the ID of any specific KE. This event is identified either because an input vector falls within the ID sphere of an existing KE or because the algorithm constructs a new KE based on the input vector. If the operation identifies the input vector as a member of an existing KE or a new KE, operation 3512 identifies the input vector as a member of this KE, for example by updating the associated metadata. The method proceeds via a connector operation A1 to operation 3540 where the identified KE to which the input vector was classified is displayed. The method ends in operation 3450.

However if operation 3510 determines that the input vector is not within the ID of any KE, the method proceeds to operation 3520 where the neighboring KEs of that input vector are determined. In operation 3522 parameters that could help classify with higher probability the input vector as a member of one of the neighboring KEs are selected. Similarly operation 3524 identifies parameters that do not contribute to the distinction between the neighboring KE may be removed. For example, if the classification process leading to this stage was not able to distinguish between, e.g., a mountain lion and a bobcat, operation 3522 may identify, based on the stored information in the classification model, that the ratio between the length of the tail and the size of the body as a parameter needs to be added. Similarly, operation 3524 may identify, based on the stored information in the classification model, the number of legs the object has as a redundant parameter that does not need to be used in the next classification phase.

The method proceeds via a connection operation A2 to operation 3530 where based on the specific neighboring KEs of the input vector the specific classification parameters are selected along with the appropriate classification model.

Operation 3532 uses the new (finer) classification model to classify the measurements based on the corresponding input vector of dimension m. For example, the new classification model attempts to refine the feline classification and distinguish between, e.g., bobcats and mountain lions.

Operation 3534 examines the classification result and specifically whether the operation was able to place the input vector within the influence sphere of a specific KE. If the classification was successful, e.g., the input measurements were identified as, e.g., a bobcat or a lion, the method proceeds to operation 3540 where the resulting classification is presented and the method ends in operation 3550. However if the classification still has some ambiguity, the method loops back via connector operation A3 to operation 3522 where new parameters are chosen along with a finer classification model, and the process repeats itself until an adequate classification is achieved.

As a result of using input vectors and classification model of with a dimension smaller than the total number of available parameters, computation complexity is reduced resulting in a more efficient algorithm. When the more efficient method runs on the same computer like existing methods, the algorithm can perform the classifications in shorter time and as such can be utilized for close to real-time operations.

Similarly, when the speed of existing algorithms is satisfactory, the use of our efficient classification method facilitate use of slower computers this resulting in a substantial cost savings.

The discussion above with respect to FIGS. 29A-C and FIG. 30 provided a reflection of simplified use cases of supervised learning. As part of the supervised learning the system model was trained to provide high probability classification, e.g., with probability of 1, of input vectors which fell within the influence sphere of a knowledge element (KE). However, when tagged vectors are not available, the method defaults to creating a system model using unsupervised learning. In accordance with one specific implementation, rather than having a deterministic probability of 1 when an input vector falls within the ID of a KE, the system model is used to determine the centroid of the KE sphere and any input vector that falls in the vicinity of the centroid of a KE is assumed to have a probability smaller than one as illustrated below.

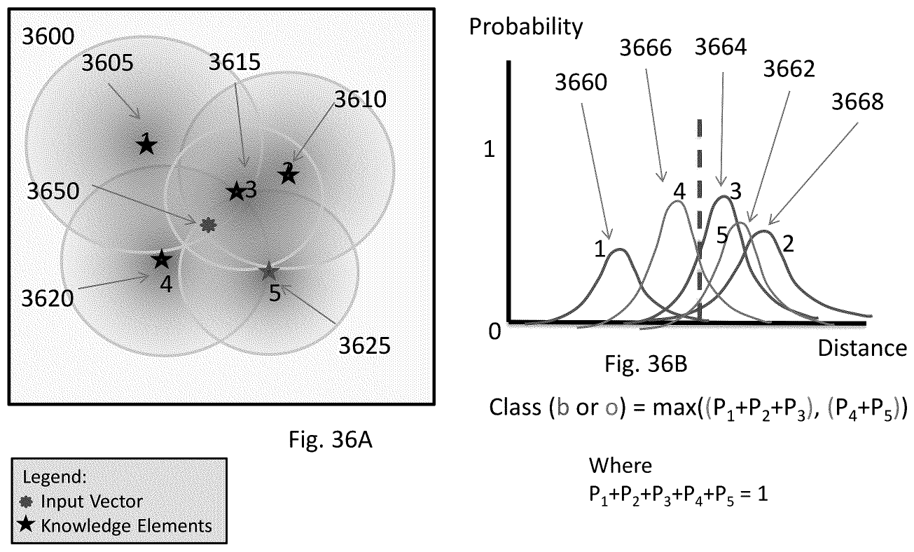

FIGS. 36A-B provide a simplified illustration 3600 of an input vector in the vicinity of KEs with decaying probability fields.

First, second and third KEs corresponding to a first class of items are illustrated by star 1 3605, star 2 3610, and star 3 3615. Fourth and fifth KEs corresponding to a second class of items are illustrated by stars 4 3620 and star 5 3625. A new input vector represented by star 3650 is presented or measured. The new input vector falls in an area that is in the proximity to all KEs.

Using Equ. 3, the method determines the probabilities that the new input vector belongs to any one of five KEs. FIG. 36B illustrates the resulting probabilities as a function of the distances between the input vector and each one of the five KEs. Specifically, the probability that the input vector falls within the first KE is illustrated by the probability curve 3660. The probability that the input vector falls within the second KE is illustrated by the probability curve 3662. The probability that the input vector falls within the third KE is illustrated by the probability curve 3664. The probability that the input vector falls within the fourth KE is illustrated by the probability curve 3666, and the probability that the input vector falls within the fifth KE is illustrated by the probability curve 3668. It should be noted that because the system model in this specific use case is constructed using an unsupervised learning, the probabilities that the input vector is a member of a specific class is smaller than one. Rather, the probability is determined by a function such as a Gaussian which is illustrated by probability curves 3660, 3662, 3664, 3666, and 3668. The Gaussian probability is provided for illustration in this use case; other probability functions can be provided in various implementations.

For the specific input vector 3650, the dashed red line in FIG. 36B illustrates the location of the input vector in the multidimensional space. The method determines the probabilities that the input vector belongs to one of the classes and determines that it belongs to the class for which the probability of belonging to that class is the highest. As evident from Equ. 3, the sum of all of the probabilities (the probability that the input vector is a member of any one of the classes) in this case equals to 1. For sake of simplicity, other classes that may be present in the vicinity of the input vector are not shown.

The location of the input vector is illustrated by the vertical dashed line. In the use case illustrated in FIG. 36B the probabilities that the input vector belongs to either class 1 or class 2 are substantially equivalent and as such the input vector resides on the boundary between these two classes

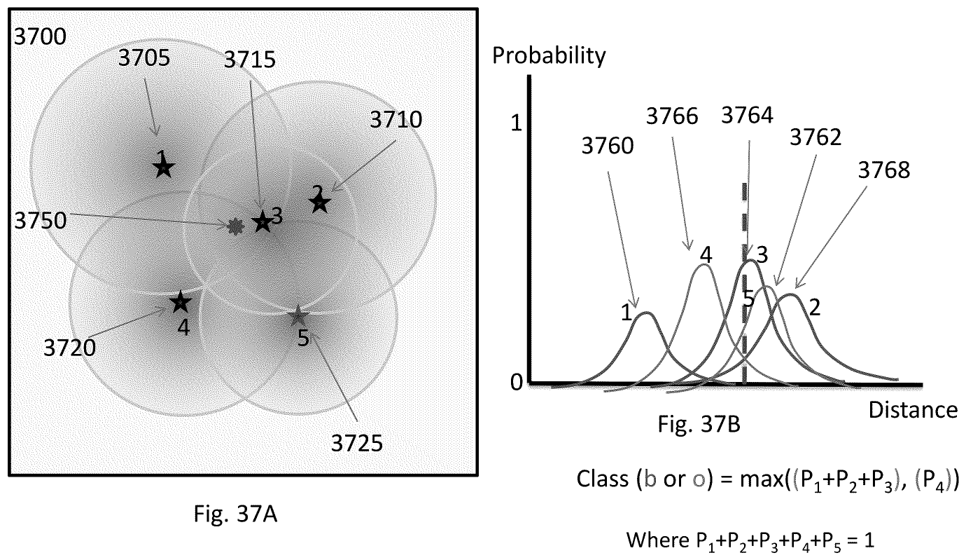

FIGS. 37A-B provide a simplified illustration of another input vector in the vicinity of KEs with decaying probability fields.

First, second and third KEs corresponding to a first class of items are illustrated by start 1 3705, star 2 3710, and star 3 3715. Fourth and fifth KEs corresponding to a second class of items are illustrated by stars 4 3720 and star 5 3725. A new input vector represented by star 3750 is presented or measured. The new input vector falls in an area that is in the proximity to all KEs.

Using Equ. 3, the method determines the probabilities that the new input vector belongs to any one of five KEs. FIG. 37B illustrates the resulting probabilities as a function of the distances between the input vector and each one of the five KEs. Specifically, the probability that the input vector falls within the first KE is illustrated by the probability curve 3760. The probability that the input vector falls within the second KE is illustrated by the probability curve 3762. The probability that the input vector falls within the third KE is illustrated by the probability curve 3764. The probability that the input vector falls within the fourth KE is illustrated by the probability curve 3766, and the probability that the input vector falls within the fifth KE is illustrated by the probability curve 3768. As explained above, because the process of creating the system model uses an unsupervised learning, the resulting classification probabilities are continuous such as Gaussian, or similar, rather than the shape illustrated in FIGS. 29A-C and 30.

As evident from Equ. 3, the sum of all of the probabilities (the probability that the input vector is a member of any one of the classes) in this case equals to 1. For sake of simplicity, other classes that may be present in the vicinity of the input vector are not shown.

The location of the input vector is illustrated by the vertical dashed line. As can be seen from the illustrated probabilities, the probability that the input belongs to the third class is substantially greater than the other probabilities and as such the method determines that the input vector is a member of the third class

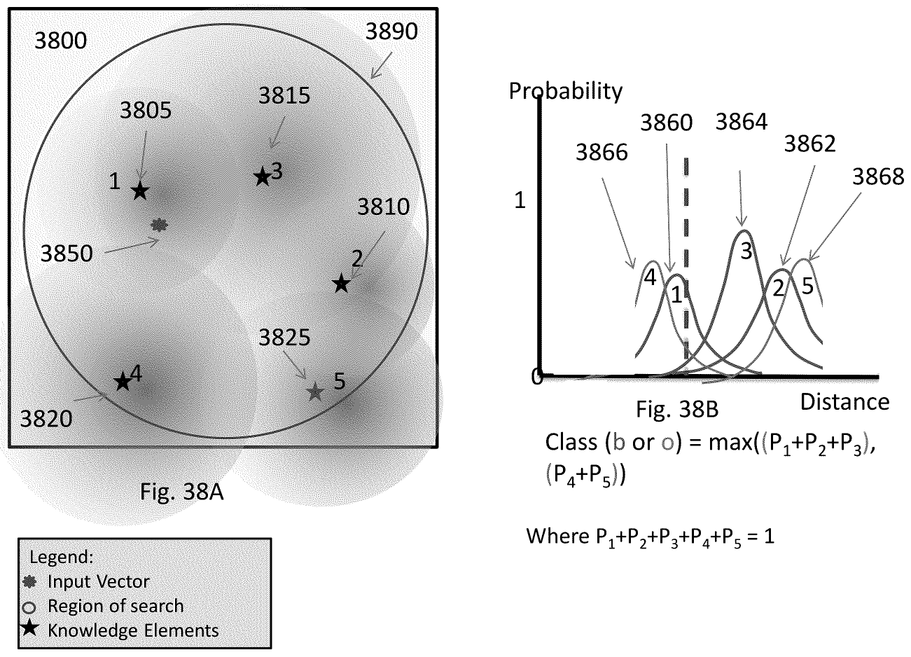

FIGS. 38A-B provide a simplified illustration of class probabilities given a defined radius of vector space with the input vector as its centroid. In this specific case there are only 5 KEs and the input vector must be a member of one of these 5 classes. Given the fact that all of the input vectors are confined to a specific neighborhood 3890, any input vector that falls outside the defined neighborhood 3890 is considered to be an error and as such the probability that it belongs to any one of the abovementioned classes is undefined.

First, second and third KEs corresponding to a first class of items are illustrated by star 1 3805, star 2 3810, and star 3 3815. Fourth and fifth KEs corresponding to a second class of items are illustrated by stars 4 3820 and star 5 3825. A new input vector represented by star 3850 is presented or measured. The new input vector falls in an area that is in the proximity to all KEs

Using Equ. 3, the method determines the probabilities that the new input vector belongs to any one of five KEs. FIG. 38B illustrates the resulting probabilities as a function of the distances between the input vector and each one of the five KEs. Specifically, the probability that the input vector falls within the first KE is illustrated by the probability curve 3860. The probability that the input vector falls within the second KE is illustrated by the probability curve 3862. The probability that the input vector falls within the third KE is illustrated by the probability curve 3864. The probability that the input vector falls within the fourth KE is illustrated by the probability curve 3866, and the probability that the input vector falls within the fifth KE is illustrated by the probability curve 3868. It should be noted that because the system model in this specific use case is constructed using an unsupervised learning, the probabilities that the input vector is a member of a specific class is smaller than one Rather, the probability is determined by a function such as a Gaussian which is illustrated by probability curves 3860, 3862, 3864, 3866, and 3868.

For the specific input vector 3850, the dashed red line in FIG. 38B illustrates the location of the input vector in the multidimensional space. The method determines the probabilities that the input vector belongs to one of the classes and determines that it belongs to the class for which the probability of belonging to that class is the highest. As evident from Equ. 3, the sum of all of the probabilities (the probability that the input vector is a member of any one of the classes) in this case equals to 1. The figure shows the probabilities within the neighborhood of interest 3890 and indicates that the probabilities are not defined beyond the boundaries of that neighborhood.

The location of the input vector is illustrated by the vertical dashed line. In the use case illustrated in FIG. 38B the probability that the input vector is a member of the first KE is the highest and as such the input vector is classified as a member of the first class.

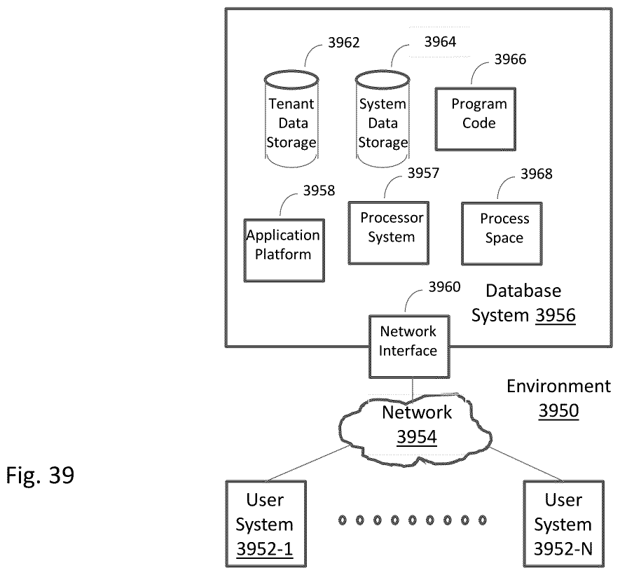

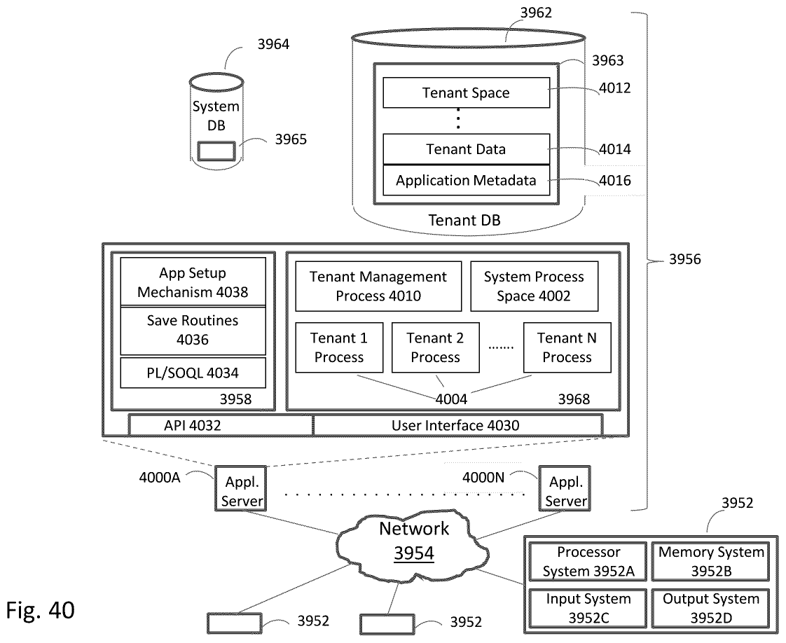

FIG. 39 shows a block diagram of an environment 3950 wherein classification probability determination may be performed, in accordance with some implementations. Environment 3950 includes an on-demand database service. User system 3952 may be any machine or system that is used by a user to access a database service. For example, any of user systems 3952 can be a handheld computing system, a mobile phone, a laptop computer, a workstation, and/or a network of computing systems. As illustrated in FIGS. 39 and 40, user systems 3952 might interact via a network 3954 with the on-demand database service.

An on-demand database service, such as a system 3956, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 3956” and “system 3956” will be used interchangeably herein. A database image may include one or more database objects. A relational database management system (RDBMS) or the equivalent may execute storage and retrieval of information against the database object(s). Application platform 3958 may be a framework that allows the applications of system 3956 to run, such as the hardware and/or software, e.g., the operating system. In an implementation, on-demand database service 956 may include an application platform 958 that enables creation, managing and executing one or more applications developed by the provider of the on-demand database service, users accessing the on-demand database service via user systems 3952, or third party application developers accessing the on-demand database service via user systems 3952.

One arrangement for elements of system 3956 is shown in FIGS. 39 and 40, including a network interface 3960, application platform 3958, tenant data storage 3962 for tenant data 3963, system data storage 3964 for system data 3965 accessible to system 3956 and possibly multiple tenants, program code 3966 for implementing various functions of system 3956, and a process memory space 3968 for executing time-sharing computer operating system such as MTS system processes and tenant-specific processes, such as running applications as part of an application hosting service. Additional processes that may execute on system 3956 include database indexing processes.

The users of user systems 3952 may differ in their respective capacities, and the capacity of a particular user system 3952 might be entirely determined by permissions (permission levels) for the current user. Thus, different users may have different capabilities with regard to accessing and modifying application and database information, depending on a user's security or permission level.

Network 3954 is any network or combination of networks of devices that communicate with one another. For example, network 3954 can be any one or any combination of a LAN (local area network), WAN (wide area network), telephone network, wireless network, optical network, point-to-point network, star network, token ring network, hub network, or other appropriate configuration. As the most common type of computer network in current use is a TCP/IP (Transfer Control Protocol and Internet Protocol) network (e.g., the Internet), that network will be used in many of the examples herein. However, it should be understood that the networks used in some implementations are not so limited, although TCP/IP is a frequently implemented protocol.

User systems 3952 might communicate with system 3956 using TCP/IP and, at a higher network level, use other common Internet protocols to communicate, such as HTTP, FTP, AFS, WAP, etc. In an example where HTTP is used, user system 3952 might include an HTTP client commonly referred to as a “browser” for sending and receiving HTTP messages to and from an HTTP server at system 3956. Such an HTTP server might be implemented as the sole network interface between system 3956 and network 3954, but other techniques might be used as well or instead. In some implementations, the interface between system 3956 and network 3954 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In some implementations, system 3956 includes application servers configured to implement and execute anomaly detection software applications as well as provide related data, code, forms, webpages and other information to and from user systems 3952 and to store to, and retrieve from, a database system related data, objects, and webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. For example, system 3956 may provide tenant access to multiple hosted (standard and custom) applications. User (or third party developer) applications may be supported by the application platform 3958, which manages creation, storage of the applications into one or more database objects and executing of the applications in a virtual machine in the process space of the system 3956.

Each user system 3952 could include a desktop personal computer, workstation, laptop, PDA, cell phone, or any wireless access protocol (WAP) enabled device or any other computing system capable of interfacing directly or indirectly to the Internet or other network connection. User system 3952 typically runs an HTTP client, e.g., a browsing program, such as Microsoft's Internet Explorer® browser, Mozilla's Firefox® browser, Opera's browser, or a WAP-enabled browser in the case of a cell phone, PDA or other wireless device, or the like, allowing a user (e.g., subscriber of the multi-tenant database system) of user system 3952 to access, process and view information, pages and applications available to it from system 3956 over network 3954.

In accordance with another implementation, user system 3952 may run a dedicated program to access database system 3956.

Each user system 3952 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 3956 or other systems or servers. For example, the user interface device can be used to access data and applications hosted by system 3956, and to perform searches on stored data, and otherwise allow a user to interact with various GUI pages that may be presented to a user. As discussed above, implementations are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

In accordance with another implementation user system 3952 includes a microphone that enables the user to interact with the system using speech and natural language recognition (NLR) or natural language processing (NLP).

According to some implementations, each user system 3952 and all of its components are operator configurable using applications, such as a browser, including computer code run using a central processing unit such as an Intel Pentium® processor or the like. Similarly, system 3956 (and additional instances of an MTS, where more than one is present) and all of their components might be operator configurable using application(s) including computer code to run using a central processing unit such as processor system 3957, which may include an Intel Pentium® processor or the like, and/or multiple processor units.

A computer program product implementation includes a machine-readable storage medium (media) having instructions stored thereon/in which can be used to program a computer to perform any of the processes of the implementations described herein. Computer code for operating and configuring system 3956 to intercommunicate and to process webpages, applications and other data and media content as described herein are preferably downloaded and stored on a hard disk, but the entire program code, or portions thereof, may also be stored in any other volatile or non-volatile memory medium or device, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, or transmitted over any other conventional network connection (e.g., extranet, VPN, LAN, etc.) using any communication medium and protocols (e.g., TCP/IP, HTTP, HTTPS, Ethernet, etc.). It will also be appreciated that computer code for carrying out disclosed operations can be implemented in any programming language that can be executed on a client system and/or server or server system such as, for example, C, C++, Python, R, HTML, any other markup language, Java™, JavaScript®, ActiveX®, any other scripting language, such as VBScript, and many other programming languages as are well known may be used. (Java™ is a trademark of Sun Microsystems®, Inc.).

According to some implementations, each system 3956 is configured to provide webpages, forms, applications, data and media content to user (client) systems 3952 to support the access by user systems 3952 as tenants of system 3956. As such, system 3956 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include logically and/or physically connected servers distributed locally or across one or more geographic locations. Additionally, the term “server” is meant to include a computing system, including processing hardware and process space(s), and an associated storage system and database application (e.g., OODBMS or RDBMS) as is well known in the art.

It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 40 also shows a block diagram of environment 3950 further illustrating system 3956 and various interconnections, in accordance with some implementations. FIG. 40 shows that user system 3952 may include processor system 3952A, memory system 3952B, input system 3952C, and output system 3952D. FIG. 40 shows network 3954 and system 3956. FIG. 40 also shows that system 3956 may include tenant data storage 3962, tenant data 3963, system data storage 3964, system data 3965, User Interface (UI) 4030, Application Program Interface (API) 4032, PIJSOQL 4034, save routines 4036, application setup mechanism 4038, applications servers 4000A-4000N, system process space 4002, tenant process spaces 4004, tenant management process space 4010, tenant storage area 4012, tenant storage 4014, and application metadata 4016. In other implementations, environment 3950 may not have the same elements as those listed above and/or may have other elements instead of, or in addition to, those listed above.

User system 3952, network 3954, system 3956, tenant data storage 3962, and system data storage 3964 were discussed above in FIG. 39. Regarding user system 3952, processor system 3952A may be any combination of processors. Memory system 3952B may be any combination of one or more memory devices, short term, and/or long term memory. Input system 3952C may be any combination of input devices, such as keyboards, mice, trackballs, scanners, microphone, cameras, and/or interfaces to networks. Output system 3952D may be any combination of output devices, such as monitors, printers, speakers, and/or interfaces to networks. As shown by FIG. 40, system 3956 may include a network interface 3960 (of FIG. 39) implemented as a set of HTTP application executing on servers 4000, an application platform 3958, tenant data storage 3962, and system data storage 3964. Also shown is system process space 4002, including individual tenant process spaces 4004 and a tenant management process space 4010. Each application server 4000 may be configured to tenant data storage 3962 and the tenant data 3963 therein, and system data storage 3964 and the system data 3965 therein to serve requests of user systems 3952. The tenant data 3963 might be divided into individual tenant storage areas 4012, which can be either a physical arrangement and/or a logical arrangement of data. Within each tenant storage area 4012, tenant storage 4014 and application metadata 4016 might be similarly allocated for each user. For example, a copy of a user's most recently used (MRU) items might be stored to tenant storage 4014. Similarly, a copy of MRU items for an entire organization that is a tenant might be stored to tenant storage area 4012. A UI 4030 provides a user interface and an API 4032 provides an application programmer interface to system 3956 resident processes to users and/or developers at user systems 3952. The tenant data and the system data may be stored in various databases, such as Oracle™ databases.

Application platform 3958 includes an application setup mechanism 4038 that supports application developers' creation and management of applications, which may be saved as metadata into tenant data storage 3962 by save routines 4036 for execution by subscribers as tenant process spaces 4004 managed by tenant management process 4010 for example. Invocations to such applications may be coded using PIJSOQL 4034 that provides a programming language style interface extension to API 4032. Invocations to applications may be detected by system processes, which manage retrieving application metadata 4016 for the subscriber making the invocation and executing the metadata as an application in a virtual machine.

Each application server 4000 may be communicably coupled to database systems, e.g., having access to system data 3965 and tenant data 3963, via a different network connection. For example, one application server 4000 might be coupled via the network 3954 (e.g., the Internet), another application server 4000 might be coupled via a direct network link, and another application server 4000 might be coupled by yet a different network connection. Transfer Control Protocol and Internet Protocol (TCP/IP) are typical protocols for communicating between application servers 4000 and the database system. However, other transport protocols may be used to optimize the system depending on the network interconnect used.

In certain implementations, each application server 4000 is configured to handle requests for any user associated with any organization that is a tenant Because it is desirable to be able to add and remove application servers from the server pool at any time for any reason, there is preferably no server affinity for a user and/or organization to a specific application server 4000. In some implementations, therefore, an interface system implementing a load balancing function (e.g., an F5 Big-IP load balancer) is communicably coupled between the application servers 4000 and the user systems 3952 to distribute requests to the application servers 4000. In some implementations, the load balancer uses a least connections algorithm to route user requests to the application servers 4000. Other examples of load balancing algorithms, such as round robin and observed response time, also can be used. For example, in certain implementations, three consecutive requests from the same user could hit three different application servers 4000, and three requests from different users could hit the same application server 4000. In this manner, system 3956 is multi-tenant, wherein system 3956 handles storage of, and access to, different objects, data and applications across disparate users and organizations.

In certain implementations, user systems 3952 (which may be client machines/systems) communicate with application servers 4000 to request and update system-level and tenant-level data from system 3956 that may require sending one or more queries to tenant data storage 3962 and/or system data storage 3964. System 3956 (e.g., an application server 4000 in system 3956) automatically generates one or more SQL statements (e.g., SQL queries) that are designed to access the desired information. System data storage 964 may generate query plans to access the requested data from the database.

These and other aspects of the disclosure may be implemented by various types and combinations of hardware, software, firmware, etc. For example, some features of the disclosure may be implemented, at least in part, by computer program products that include program instructions, state information, etc., for performing various operations described herein. Examples of program instructions include both machine code, such as produced by a compiler, and files containing higher-level code that may be executed by the computer using an interpreter. Examples of computer program product include, but are not limited to, magnetic media such as hard disks, floppy disks, and magnetic tape; optical media such as CD-ROM disks; magneto-optical media; and hardware devices that are specially configured to store and perform program instructions, such as read-only memory devices (“ROM”) and random access memory (“RAM”).

While one or more implementations and techniques are described with reference to a system having an application server providing a front end for an on-demand database service capable of supporting multiple tenants, the one or more implementations and techniques are not limited to multi-tenant databases or deployment on application servers. Implementations may be practiced using other database architectures, i.e., ORACLE®, DB2® D by IBM and the like without departing from the scope of the implementations claimed.

Programmable logic devices (PLDs) are a type of digital integrated circuit that can be programmed to perform specified logic functions. One type of PLD, the field programmable gate array (FPGA), typically includes an array of configurable logic blocks (CLBS) surrounded by a ring of programmable input/output blocks (IOBs). Some FPGAs also include additional logic blocks with special purposes (Digital Signal Processing (DSP) blocks, Random Access Memory (RAM) blocks, Phase Lock Loops (PLL), and so forth). FPGA logic blocks typically include programmable logic elements such as lookup tables (LUTs), flip flops, memory elements, multiplexers, and so forth. The LUTs are typically implemented as RAM arrays in which values are stored during configuration (i.e., programming) of the FPGA. The flip-flops, multiplexers, and other components may also be programmed by writing configuration data to configuration memory cells included in the logic block. For example, the configuration data bits can enable or disable elements, alter the aspect ratios of memory arrays, select latch or flip-flop functionality for a memory element, and so forth. The configuration data bits can also select interconnection between the logic elements in various ways within a logic block by programmatically selecting multiplexers inserted in the interconnect paths within CLB and between CLBs and IOBs.

While a number of aspects and implementations have been disclosed herein, those of skill in the art will recognize certain modifications, permutations, additions and sub-combinations thereof. It is therefore intended that the scope of this disclosure includes all such modifications, permutations, additions and sub-combinations. For example, the use of virtual knowledge elements in connection with physical engines can be implemented in other programmable logic circuits and in application specific integrated circuits (ASICs). An additional example would be where external memories (host based or local to the pattern recognition machine) are used to supplement the FPGA or ASIC “on-chip” memory to provide for larger numbers of knowledge elements. It is therefore not intended that the disclosure be limited except as indicated by the appended claims.

The disclosure is therefore not limited with respect to the network location where the operations are performed (e.g., cloud-based computing, edge computing, local computing, or any combination thereof). Nor is the disclosure limited to specific computing devices or computing techniques configured to perform the anomaly detection techniques described herein.

What is claimed is:

1. A multistage classification system comprising:
a memory;
one or more processors; and
logic operable to cause the one or more processors to:
obtain, in association with a learning process, a plurality of input vectors, iteratively process an input vector through an iteratively constructed stage based system model,
determine whether the iterative process identified the input vector as belonging to a class,
in response to determining that classification has not been achieved, continue to iteratively process through the stage based system model, and
in response to determining that classification has been achieved, cause an action to be taken.

2. The multistage classification system of claim 1, the learning process including one or more of:
obtaining the plurality of input vectors;
identifying a subset of input vector dimensions;
constructing new training vectors using the identified subset of input vector dimensions;
constructing a stage knowledge map based on the new input training vectors; or
storing the identified subset of input vector dimensions and the knowledge map in association with an identification stage.

3. The multistage classification system of claim 2, wherein the learning process is configured to continue iteratively until a classification of the input vectors is achieved.

4. The multistage classification system of claim 2, wherein iterations of the learning process use different elements of an input vector.

5. The multistage classification system of claim 1, the identification of an input vector as belonging to a class including one or more of:
obtaining the input vector;
retrieving a subset of input vector dimensions and a knowledge map associated with an identification stage;
constructing a new input vector using the input vector and the subset of input vector dimensions; or
processing the new input vector through a stage knowledge map.

6. The multistage classification system of claim 5, wherein iterations of the classification use different elements of the input vector.

7. The multistage classification system of claim 5, wherein in response to determining that classification has not been achieved:
perform logic to determine whether related stages were exercised;
continue to iterate through stages in response to determining that not all of the related stages have been exercised; and
in response to determining that all of the related stages have been exercised, determine a probability of the input vector belonging to one or more classes based on neighboring classes.

8. The multistage classification system of claim 1, wherein the action includes one or more of:
generating an alert that the input vector is related to a class, or determining that the input vector belongs to the class with a probability of substantially one.

9. A non-transitory computer-readable medium storing computer-readable program code executable by one or more processors, the program code comprising instructions configured to cause:
obtaining, in association with a learning process, a plurality of input vectors;
iteratively processing an input vector through an iteratively constructed stage based system model;
determining whether the iterative process identified the input vector as belonging to a class;
in response to determining that classification has not been achieved, continue iteratively processing through the stage based system model; and
in response to determining that classification has been achieved, causing an action to be taken.

10. The non-transitory computer-readable medium of claim 9, the learning process including one or more of:
obtaining the plurality of input vectors;
identifying a subset of input vector dimensions;
constructing new training vectors using the identified subset of input vector dimensions;
constructing a stage knowledge map based on the new input training vectors; or
storing the identified subset of input vector dimensions and the knowledge map in association with an identification stage.

11. The non-transitory computer-readable medium of claim 10, wherein the learning process is configured to continue iteratively until a classification of the input vectors is achieved.

12. The non-transitory computer-readable medium of claim 10, wherein iterations of the learning process use different elements of an input vector.

13. The non-transitory computer-readable medium of claim 9, the identification of an input vector as belonging to a class including one or more of:
obtaining the input vector;
retrieving a subset of input vector dimensions and a knowledge map associated with an identification stage;
constructing a new input vector using the input vector and the subset of input vector dimensions; or
processing the new input vector through a stage knowledge map.

14. The non-transitory computer-readable medium of claim 13, wherein iterations of the classification use different elements of the input vector.

15. The non-transitory computer-readable medium of claim 13, wherein in response to determining that classification has not been achieved:
performing logic to determine whether related stages were exercised;
continue iterating through stages in response to determining that not all of the related stages have been exercised; and
in response to determining that all of the related stages have been exercised, determining a probability of the input vector belonging to one or more classes based on neighboring classes.

16. The non-transitory computer-readable medium of claim 9, wherein the action includes one or more of: generating an alert that the input vector is related to a class, or determining that the input vector belongs to the class with a probability of substantially one.

17. A computer-implemented method comprising:
obtaining, in association with a learning process, a plurality of input vectors;
iteratively processing an input vector through an iteratively constructed stage based system model;
determining whether the iterative process identified the input vector as belonging to a class;
in response to determining that classification has not been achieved, continue iteratively processing through the stage based system model; and
in response to determining that classification has been achieved, causing an action to be taken.

18. The computer-implemented method of claim 17, the learning process including one or more of:
obtaining the plurality of input vectors;
identifying a subset of input vector dimensions;
constructing new training vectors using the identified subset of input vector dimensions;
constructing a stage knowledge map based on the new input training vectors; or
storing the identified subset of input vector dimensions and the knowledge map in association with an identification stage.

19. The computer-implemented method of claim 18, wherein the learning process is configured to continue iteratively until a classification of the input vectors is achieved.

20. The computer-implemented method of claim 18, wherein iterations of the learning process use different elements of an input vector.

21. The computer-implemented method of claim 17, the identification of an input vector as belonging to a class including one or more of:
obtaining the input vector;
retrieving a subset of input vector dimensions and a knowledge map associated with an identification stage;
constructing a new input vector using the input vector and the subset of input vector dimensions; or
processing the new input vector through a stage knowledge map.

22. The computer-implemented method of claim 21, wherein iterations of the classification use different elements of the input vector.

23. The computer-implemented method of claim 21, wherein in response to determining that classification has not been achieved:
performing logic to determine whether related stages were exercised;
continue iterating through stages in response to determining that not all of the related stages have been exercised; and
in response to determining that all of the related stages have been exercised, determining a probability of the input vector belonging to one or more classes based on neighboring classes.

24. The computer-implemented method of claim 17, wherein the action includes one or more of: generating an alert that the input vector is related to a class, or determining that the input vector belongs to the class with a probability of substantially one.
